(19) United States
(12) Patent Application Publication
(10) Pub. No.: US 2021/0243767 A1
(43) Pub. Date: Aug. 5, 2021

(54) TERMINAL APPARATUS, BASE STATION APPARATUS, AND COMMUNICATION METHOD

(71) Applicant: SHARP KABUSHIKI KAISHA, Sakai City, Osaka (JP)

(72) Inventors: SHOICHI SUZUKI, Sakai City, Osaka (JP); TOMOKI YOSHIMURA, Sakai City, Osaka (JP); TOSHIZO NOGAMI, Sakai City, Osaka (JP); WATARU OUCHI, Sakai City, Osaka (JP); TAEWOO LEE, Sakai City, Osaka (JP); HUIFA LIN, Sakai City, Osaka (JP)

(21) Appl. No.: 17/270,432

(22) PCT Filed: Aug. 22, 2019
(86) PCT No.: PCT/JP2019/032914

§ 371 Date: Apr. 6, 2021

(30) Foreign Application Priority Data
Aug. 23, 2018 (JP) 2018-156354

(51) Int. Cl. H04W 72/04; H04W 76/11

(52) U.S. Cl. CPC H04W 72/0493; H04W 76/11; H04W 72/0453; H04W 72/042

(57) ABSTRACT

Communication can be efficiently performed. In a case that a terminal apparatus is configured to monitor a first PDCCH candidate in a CSS and a second PDCCH candidate in a USS according to a DCI format accompanied with a C-RNTI in one non-interleaved CORESET having a period of one OFDM symbol, an aggregation level of the first PDCCH candidate is 8, an aggregation level of the second PDCCH candidate is 16, a lowest index of a CCE constituting the first PDCCH candidate is the same as a lowest index of a CCE constituting the second PDCCH candidate, a higher layer parameter PDCCH-DMRS-Scrambling-ID is not configured for the CORESET, and a size of the DCI format corresponding to the first PDCCH candidate is the same as a size of the DCI format corresponding to the second PDCCH candidate, it is considered that the DCI format is transmitted only in the first PDCCH candidate.

### TECHNICAL FIELD

The present invention relates to a terminal apparatus, a base station apparatus, and a communication method. This application claims priority based on JP 2018-156354 filed on Aug. 23, 2018, the contents of which are incorporated herein by reference.

### BACKGROUND ART

A radio access method and a radio network for cellular mobile communications (hereinafter referred to as “Long Term Evolution (LTE: Registered Trademark)”, or “Evolved Universal Terrestrial Radio Access (EUTRA)”) have been studied in the 3rd Generation Partnership Project (3GPP) (NPLs 1, 2, 3, 4, and 5). In 3GPP, a new radio access method (hereinafter referred to as “New Radio (NR)”) has been studied. In LTE, a base station apparatus is also referred to as an evolved NodeB (eNodeB). In NR, a base station apparatus is also referred to as a gNodeB. In LTE and in NR, a terminal apparatus is also referred to as a User Equipment (UE). LTE, as well as NR, are cellular communication systems in which multiple areas are deployed in a cellular structure, with each of the multiple areas being covered by a base station apparatus. A single base station apparatus may manage multiple cells.

In the downlink of NR, a PDCCH, a PUSCH, and a PDSCH are used (NPLs 1, 2, 3, and 4). On the PDCCH, Downlink Control Information (DCI) is transmitted. DCI format 0_0 is used for scheduling of the PUSCH. DCI format 1_0 is used for scheduling of the PDSCH.

### CITATION LIST

### Non Patent Literature

NPL 1: “3GPP TS 38.211 V15.2.0 (2018-06), NR; Physical channels and modulation”, 29 Jun. 2017.

NPL 2: “3GPP TS 38.212 V15.2.0 (2018-06), NR; Multiplexing and channel coding”, 29 Jun. 2017.

NPL 3: “3GPP TS 38.213 V15.2.0 (2018-06), NR; Physical layer procedures for control”, 29 Jun. 2017.

NPL 4: “3GPP TS 38.214 V15.2.0 (2018-06), NR; Physical layer procedures for data”, 29 Jun. 2017.

### SUMMARY OF INVENTION

### Technical Problem

In one aspect of the present invention, a terminal apparatus, a communication method used for the terminal apparatus, a base station apparatus, and a communication method used for the base station apparatus are provided. The terminal apparatus, the communication method used for the terminal apparatus, the base station apparatus, and the communication method used for the base station apparatus according to one aspect of the present invention include a method of determining a size of information and/or a method of efficiently interpreting the information.

### Solution to Problem

(1) According to some aspects of the present invention, the following measures are provided. Specifically, a first aspect of the present invention is a terminal apparatus. The terminal apparatus includes: at least one processor; and a memory coupled to the at least one processor. The processor receives a physical downlink control channel (PDCCH) accompanied with a downlink control information (DCI) format, and receives a physical downlink shared channel (PDSCH) corresponding to a resource indication value (RIV) set to a “Frequency domain resource assignment” field of the DCI format. The RIV is given based on at least a type of a search space in which the PDCCH is detected. (1) In a case that the terminal apparatus is configured to monitor a first PDCCH candidate in a common search space (CSS) and a second PDCCH candidate in a UE-specific search space (USS) according to the DCI format accompanied with a cell radio network temporary identifier (C-RNTI) in one control resource set (CORESET), (2) in a case that a period of the CORESET is one orthogonal frequency division multiplexing (OFDM) symbol, (3) in a case that the CORESET is a non-interleaved CORESET, (4) in a case that one of the first PDCCH candidate and the second PDCCH candidate is of an aggregation level of 8 while another is of an aggregation level of 16, (5) in a case that a lowest index of a control channel element (CCE) constituting the first PDCCH candidate is identical to a lowest index of a CCE constituting the second PDCCH candidate, (6) in a case that a higher layer parameter PDCCH-DMRS-Scrambling-ID is not configured for the CORESET, and/or (7) in a case that a size of the DCI format corresponding to the first PDCCH candidate is identical to a size of the DCI format corresponding to the second PDCCH candidate, the processor considers that the PDCCH accompanied with the DCI format is transmitted only in the first PDCCH candidate out of the first PDCCH candidate and the second PDCCH candidate, or considers that the PDCCH accompanied with the DCI format is transmitted only in the second PDCCH candidate out of the first PDCCH candidate and the second PDCCH candidate, or considers that the PDCCH accompanied with the DCI format is transmitted or received in the second PDCCH candidate in a case that the PDCCH accompanied with the DCI format is received in the first PDCCH candidate, or considers that the PDCCH accompanied with the DCI format is transmitted or received in the first PDCCH candidate in a case that the PDCCH accompanied with the DCI format is received in the second PDCCH candidate, or considers that the PDCCH accompanied with the DCI format is transmitted only in the PDCCH candidate having the aggregation level of 8 out of the first PDCCH candidate and the second PDCCH candidate, or considers that the PDCCH accompanied with the DCI format is transmitted only in the PDCCH candidate having the aggregation level of 16 out of the first PDCCH candidate and the second PDCCH candidate, or considers that the PDCCH accompanied with the DCI format is transmitted or received in the PDCCH candidate having the aggregation level of 16 in a case that the PDCCH accompanied with the DCI format is detected in the PDCCH candidate having the aggregation level of 8, or considers that the PDCCH accompanied with the DCI format is transmitted or received in the PDCCH candidate having the aggregation level of 8 in a case that the PDCCH accompanied with the DCI format is detected in the PDCCH candidate having the aggregation level of 16.

(2) A second aspect of the present invention is a base station apparatus. The base station apparatus includes: at least one processor; and a memory coupled to the at least one processor. The processor transmits a physical downlink control channel (PDCCH) accompanied with a downlink control information (DCI) format, and transmits a physical downlink shared channel (PDSCH) corresponding to a resource indication value (RIV) set to a “Frequency domain resource assignment” field of the DCI format. The RIV is given based on at least a type of a search space in which the PDCCH is detected. (1) In a case that the terminal apparatus is configured to monitor a first PDCCH candidate in a common search space (CSS) and a second PDCCH candidate in a UE-specific search space (USS) according to the DCI format accompanied with a cell radio network temporary identifier (C-RNTI) in one control resource set (CORESET), (2) in a case that a period of the CORESET is one orthogonal frequency division multiplexing (OFDM) symbol, (3) in a case that the CORESET is a non-interleaved CORESET, (4) in a case that one of the first PDCCH candidate and the second PDCCH candidate is of an aggregation level of 8 while another is of an aggregation level of 16, (5) in a case that a lowest index of a control channel element (CCE) constituting the first PDCCH candidate is identical to a lowest index of a CCE constituting the second PDCCH candidate, (6) in a case that a higher layer parameter PDCCH-DMRS-Scrambling-ID is not configured for the CORESET, and/or (7) in a case that a size of the DCI format corresponding to the first PDCCH candidate is identical to a size of the DCI format corresponding to the second PDCCH candidate, the processor transmits the PDCCH accompanied with the DCI format only in the first PDCCH candidate out of the first PDCCH candidate and the second PDCCH candidate, or transmits the PDCCH accompanied with the DCI format only in the second PDCCH candidate out of the first PDCCH candidate and the second PDCCH candidate, or considers that the PDCCH accompanied with the DCI format is transmitted in the second PDCCH candidate in a case that the PDCCH accompanied with the DCI format is transmitted in the first PDCCH candidate, or considers that the PDCCH accompanied with the DCI format is transmitted in the first PDCCH candidate in a case that the PDCCH accompanied with the DCI format is transmitted in the second PDCCH candidate, or transmits the PDCCH accompanied with the DCI format only in the PDCCH candidate having the aggregation level of 8 out of the first PDCCH candidate and the second PDCCH candidate, or transmits the PDCCH accompanied with the DCI format only in the PDCCH candidate having the aggregation level of 16 out of the first PDCCH candidate and the second PDCCH candidate, or considers that the PDCCH accompanied with the DCI format is transmitted in the PDCCH candidate having the aggregation level of 16 in a case that the PDCCH accompanied with the DCI format is transmitted in the PDCCH candidate having the aggregation level of 8, or considers that the PDCCH accompanied with the DCI format is transmitted in the PDCCH candidate having the aggregation level of 8 in a case that the PDCCH accompanied with the DCI format is transmitted in the PDCCH candidate having the aggregation level of 16.

(3) A third aspect of the present invention is a communication method for a terminal apparatus. The communication method includes the steps of: receiving a physical downlink control channel (PDCCH) accompanied with a downlink control information (DCI) format; receiving a physical downlink shared channel (PDSCH) corresponding to a resource indication value (RIV) set to a “Frequency domain resource assignment” field of the DCI format, the RIV being given based on at least a type of a search space in which the PDCCH is detected; and (1) in a case that the terminal apparatus is configured to monitor a first PDCCH candidate in a common search space (CSS) and a second PDCCH candidate in a UE-specific search space (USS) according to the DCI format accompanied with a cell radio network temporary identifier (C-RNTI) in one control resource set (CORESET), (2) in a case that a period of the CORESET is one orthogonal frequency division multiplexing (OFDM) symbol, (3) in a case that the CORESET is a non-interleaved CORESET, (4) in a case that one of the first PDCCH candidate and the second PDCCH candidate is of an aggregation level of 8 while another is of an aggregation level of 16, (5) in a case that a lowest index of a control channel element (CCE) constituting the first PDCCH candidate is identical to a lowest index of a CCE constituting the second PDCCH candidate, (6) in a case that a higher layer parameter PDCCH-DMRS-Scrambling-ID is not configured for the CORESET, and/or (7) in a case that a size of the DCI format corresponding to the first PDCCH candidate is identical to a size of the DCI format corresponding to the second PDCCH candidate, considering that the PDCCH accompanied with the DCI format is transmitted only in the first PDCCH candidate out of the first PDCCH candidate and the second PDCCH candidate, or considering that the PDCCH accompanied with the DCI format is transmitted only in the second PDCCH candidate out of the first PDCCH candidate and the second PDCCH candidate, or considering that the PDCCH accompanied with the DCI format is transmitted or received in the second PDCCH candidate in a case that the PDCCH accompanied with the DCI format is received in the first PDCCH candidate, or considering that the PDCCH accompanied with the DCI format is transmitted or received in the first PDCCH candidate in a case that the PDCCH accompanied with the DCI format is received in the second PDCCH candidate, or considering that the PDCCH accompanied with the DCI format is transmitted only in the PDCCH candidate having the aggregation level of 8 out of the first PDCCH candidate and the second PDCCH candidate, or considering that the PDCCH accompanied with the DCI format is transmitted only in the PDCCH candidate having the aggregation level of 16 out of the first PDCCH candidate and the second PDCCH candidate, or considering that the PDCCH accompanied with the DCI format is transmitted or received in the PDCCH candidate having the aggregation level of 16 in a case that the PDCCH accompanied with the DCI format is detected in the

PDCCH candidate having the aggregation level of 8, or considering that the PDCCH accompanied with the DCI format is transmitted or received in the PDCCH candidate having the aggregation level of 8 in a case that the PDCCH accompanied with the DCI format is detected in the PDCCH candidate having the aggregation level of 16.

(4) A fourth aspect of the present invention is a communication method for a base station apparatus. The communication method includes the steps of: transmitting a physical downlink control channel (PDCCH) accompanied with a downlink control information (DCI) format; transmitting a physical downlink shared channel (PDSCH) corresponding to a resource indication value (RIV) set to a “Frequency domain resource assignment” field of the DCI format, the RIV being given based on at least a type of a search space in which the PDCCH is detected; and (1) in a case that the terminal apparatus is configured to monitor a first PDCCH candidate in a common search space (CSS) and a second PDCCH candidate in a UE-specific search space (USS) according to the DCI format accompanied with a cell radio network temporary identifier (C-RNTI) in one control resource set (CORESET), (2) in a case that a period of the CORESET is one orthogonal frequency division multiplexing (OFDM) symbol, (3) in a case that the CORESET is a non-interleaved CORESET, (4) in a case that one of the first PDCCH candidate and the second PDCCH candidate is of an aggregation level of 8 while another is of an aggregation level of 16, (5) in a case that a lowest index of a control channel element (CCE) constituting the first PDCCH candidate is identical to a lowest index of a CCE constituting the second PDCCH candidate, (6) in a case that a higher layer parameter PDCCH-DMRS-Scrambling-ID is not configured for the CORESET, and/or (7) in a case that a size of the DCI format corresponding to the first PDCCH candidate is identical to a size of the DCI format corresponding to the second PDCCH candidate, transmitting the PDCCH accompanied with the DCI format only in the first PDCCH candidate out of the first PDCCH candidate and the second PDCCH candidate, or transmitting the PDCCH accompanied with the DCI format only in the second PDCCH candidate out of the first PDCCH candidate and the second PDCCH candidate, or considering that the PDCCH accompanied with the DCI format is transmitted in the second PDCCH candidate in a case that the PDCCH accompanied with the DCI format is transmitted in the first PDCCH candidate, or considering that the PDCCH accompanied with the DCI format is transmitted in the first PDCCH candidate in a case that the PDCCH accompanied with the DCI format is transmitted in the second PDCCH candidate, or transmitting the PDCCH accompanied with the DCI format only in the PDCCH candidate having the aggregation level of 8 out of the first PDCCH candidate and the second PDCCH candidate, or transmitting the PDCCH accompanied with the DCI format only in the PDCCH candidate having the aggregation level of 16 out of the first PDCCH candidate and the second PDCCH candidate, or considering that the PDCCH accompanied with the DCI format is transmitted in the PDCCH candidate having the aggregation level of 16 in a case that the PDCCH accompanied with the DCI format is transmitted in the PDCCH candidate having the aggregation level of 8, or considering that the PDCCH accompanied with the DCI format is transmitted in the PDCCH candidate having the aggregation level of 8 in a case that the PDCCH accompanied with the DCI format is transmitted in the PDCCH candidate having the aggregation level of 16.

### Advantageous Effects of Invention

According to one aspect of the present invention, the terminal apparatus and the base station apparatus can efficiently perform communication.

### BRIEF DESCRIPTION OF DRAWINGS

FIG. 1 is a conceptual diagram of a radio communication system according to the present embodiment.

FIG. 2 is a diagram illustrating a schematic configuration of a radio frame according to the present embodiment.

FIG. 3 is a diagram illustrating a schematic configuration of a downlink slot according to the present embodiment.

FIG. 4 is a schematic block diagram illustrating a configuration of a terminal apparatus 1 according to the present embodiment.

FIG. 5 is a schematic block diagram illustrating a configuration of a base station apparatus 3 according to the present embodiment.

FIG. 6 is a diagram illustrating an example of a CORESET according to the present embodiment.

FIG. 7 is a diagram illustrating an example of search spaces according to the present embodiment.

FIG. 8 is a diagram illustrating correspondence between a ‘Frequency domain resource assignment’ field and NDL, BWP and NUL, BWP according to the present embodiment.

FIG. 9 is a diagram illustrating an example of DCI format 0_0 and DCI format 1_0 according to the present embodiment.

FIG. 10 is a diagram illustrating pseudocode for calculating RIV 0_0 according to the present embodiment.

FIG. 11 is a diagram illustrating pseudocode for calculating RIV 0_0 according to the present embodiment.

FIG. 12 is a diagram illustrating pseudocode for calculating RIV 1_0 according to the present embodiment.

FIG. 13 is a diagram illustrating pseudocode for calculating RIV 1_0 according to the present embodiment.

FIG. 14 is a diagram illustrating an example of processing related to downlink control information according to the present embodiment.

FIG. 15 is a diagram illustrating an example of pseudocode for calculating C according to the present embodiment.

FIG. 16 is a diagram illustrating an example of pseudocode for generating a matrix u′ according to the present embodiment.

FIG. 17 is a diagram illustrating an example of bit selection of a sequence dᵢ according to the present embodiment.

### DESCRIPTION OF EMBODIMENTS

Embodiments of the present invention will be described below.

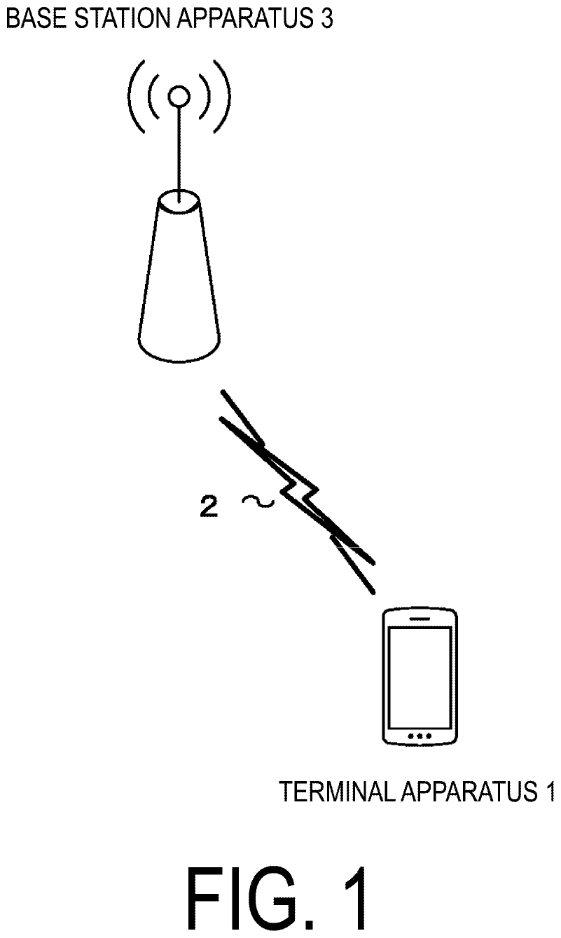

FIG. 1 is a conceptual diagram of a radio communication system according to the present embodiment. In FIG. 1, the radio communication system includes a terminal apparatus 1 and a base station apparatus 3.

Hereinafter, carrier aggregation will be described.

According to the present embodiment, one or multiple serving cells are configured for the terminal apparatus 1. A technology that allows the terminal apparatus 1 to perform communication via the multiple serving cells is referred to as cell aggregation or carrier aggregation. The present invention may be applied to each of the multiple serving cells configured for the terminal apparatus 1. Furthermore, the present invention may be applied to some of the multiple serving cells configured. The multiple serving cells include at least one primary cell. Here, the multiple serving cells may include one or multiple secondary cells. In the following, unless otherwise specifically noted, the present embodiment is applied to one serving cell.

The primary cell is a serving cell in which an initial connection establishment procedure has been performed, a serving cell in which a connection re-establishment procedure has been initiated, or a cell indicated as a primary cell in a handover procedure. The secondary cell may be configured at a point of time when or after a Radio Resource Control (RRC) connection is established.

A carrier corresponding to a serving cell in the downlink is referred to as a downlink component carrier. A carrier corresponding to a serving cell in the uplink is referred to as an uplink component carrier. A downlink component carrier and an uplink component carrier are collectively referred to as a component carrier.

The terminal apparatus 1 can perform simultaneous transmission and/or reception on multiple physical channels in multiple serving cells (component carriers). A single physical channel is transmitted in a single serving cell (component carrier) out of the multiple serving cells (component carriers).

Physical channels and physical signals according to the present embodiment will be described.

In uplink radio communication from the terminal apparatus 1 to the base station apparatus 3, the following uplink physical channels are used. The uplink physical channels are used for transmitting information output from a higher layer.
Physical Uplink Control Channel (PUCCH)
Physical Uplink Shared Channel (PUSCH)
Physical Random Access Channel (PRACH)

The PUCCH is used for transmitting Channel State Information (CSI) of downlink and/or Hybrid Automatic Repeat reQuest (HARQ-ACK). The CSI, as well as the HARQ-ACK, is Uplink Control Information (UCI).

The PUSCH is used for transmitting uplink data (Transport block, Uplink-Shared Channel (UL-SCH)), the CSI of downlink, and/or the HARQ-ACK. The CSI, as well as the HARQ-ACK, is Uplink Control Information (UCI). The terminal apparatus 1 may transmit the PUSCH, based on detection of a Physical Downlink Control Channel (PDCCH) including uplink grant.

The PRACH is used to transmit a random access preamble.

The following uplink physical signal is used in the uplink radio communication. The uplink physical signal is not used for transmitting information output from the higher layer, but is used by the physical layer.
Demodulation Reference Signal (DMRS)

The DMRS relates to transmission of the PUSCH or the PUCCH. The DMRS may be time-multiplexed with the PUSCH. The base station apparatus 3 may use the DMRS in order to perform channel compensation of the PUSCH.

The following downlink physical channels are used for downlink radio communication from the base station apparatus 3 to the terminal apparatus 1. The downlink physical channels are used for transmitting information output from the higher layer.
Physical Downlink Control Channel (PDCCH)
Physical Downlink Control Channel (PDSCH)

The PDCCH is used to transmit Downlink Control Information (DCI). The downlink control information is also referred to as DCI format.

The PDSCH is used to transmit downlink data (Transport block, Downlink-Shared Channel (DL-SCH)).

The UL-SCH and the DL-SCH are transport channels. A channel used in a Medium Access Control (MAC) layer is referred to as a transport channel. A unit of the transport channel used in the MAC layer is also referred to as a transport block (TB) or a MAC Protocol Data Unit (PDU).

A configuration of the radio frame according to the present embodiment will be described below.

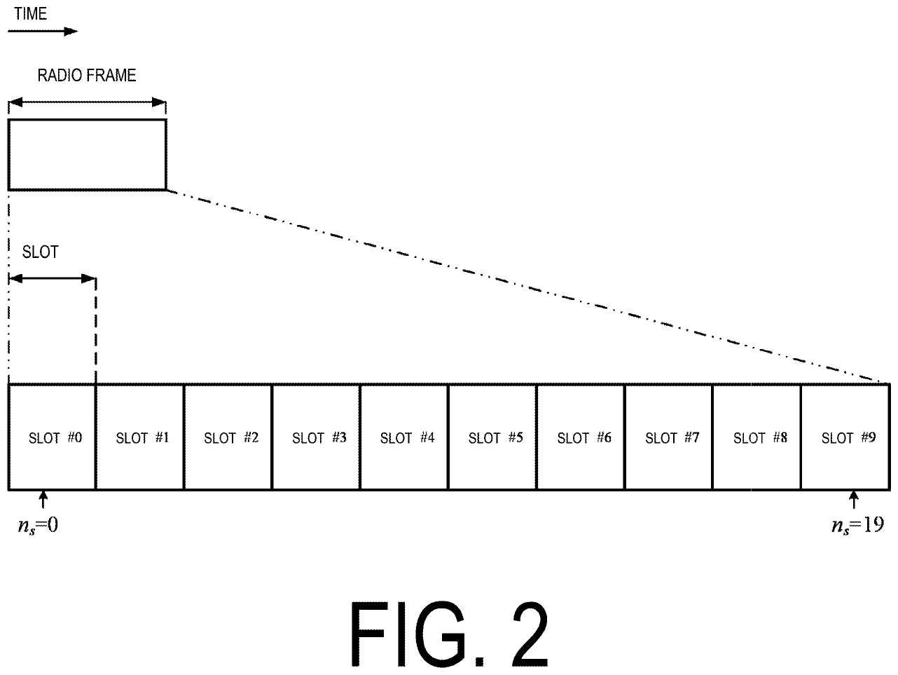

FIG. 2 is a diagram illustrating a schematic configuration of a radio frame according to the present embodiment. In FIG. 2, the horizontal axis is a time axis. Each of the radio frames may be 10 ms in length. Furthermore, each of the radio frames may include ten slots. Each of the slots may be 1 ms in length.

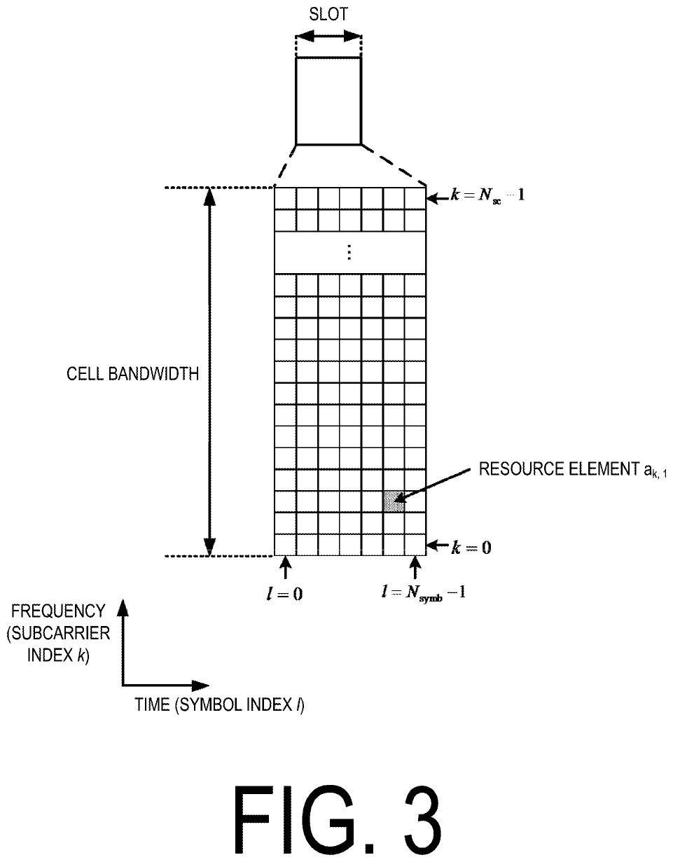

An example configuration of a slot according to the present embodiment will be described below. FIG. 3 is a schematic diagram illustrating a configuration of a slot according to the present embodiment. FIG. 3 illustrates a configuration of a slot in a cell. In FIG. 3, the horizontal axis is a time axis, and the vertical axis is a frequency axis. The slot may include N_{symb} OFDM symbols.

In FIG. 3, 1 is an OFDM symbol number/index, and k is a subcarrier number/index. The physical signal or the physical channel transmitted in each of the slots is represented by a resource grid. The resource grid is defined by multiple subcarriers and multiple OFDM symbols. Each element in the resource grid is referred to as a resource element. The resource element is represented by a subcarrier number/index k and an OFDM symbol number/index 1.

The slot includes multiple OFDM symbols 1 (1=0, 1, . . . , N_{symb}) in the time domain. For a normal Cyclic Prefix (normal CP), N_{symb} may be 14. For an extended CP, N_{symb} may be 12.

The slot includes multiple subcarriers k (k=0, 1, . . . , N_{RB}·N^{RB}_{SC}) in the frequency domain. N_{RB} is a bandwidth configuration for the serving cell, which is expressed by a multiple of N^{RB}_{SC}. N^{RB}_{SC} is a (physical) resource block size in the frequency domain represented by the number of subcarriers. The subcarrier spacing Δf may be 15 kHz. The N^{RB}_{SC} may be 12. The (physical) resource block size in the frequency domain may be 180 kHz.

One physical resource block is defined by N_{symb} continuous OFDM symbols in the time domain and N^{RB}_{SC} continuous subcarriers in the frequency domain. Hence, one physical resource block includes (N_{symb}·N^{RB}_{SC}) resource elements. One physical resource block may correspond to one slot in the time domain. The physical resource blocks may be assigned numbers np_{RB} (0, 1, . . . , N_{RB}−1) in ascending order from the physical resource block having the lowest frequency in the frequency domain.

Configurations of apparatuses according to the present embodiment will be described below.

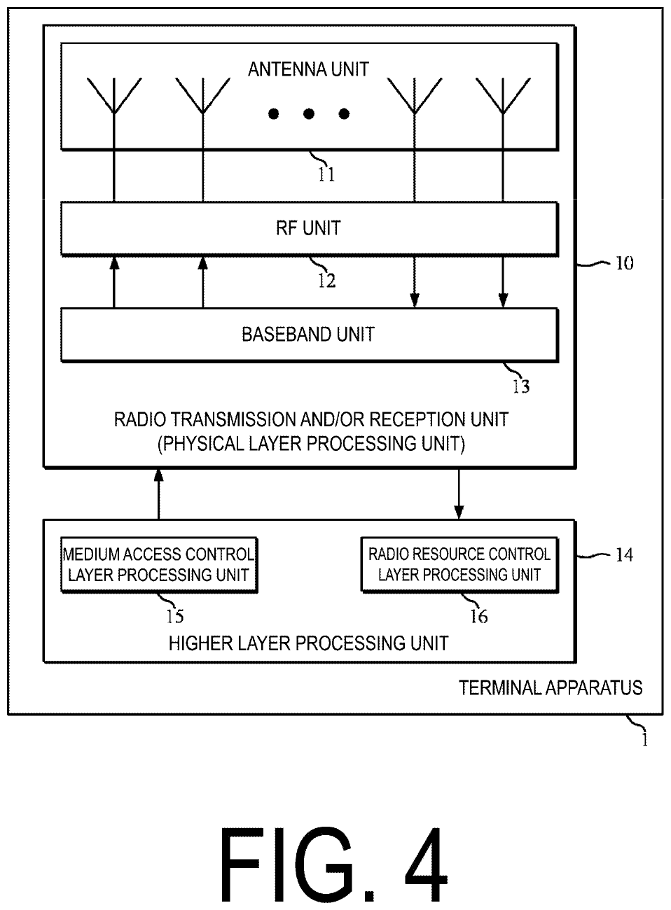

FIG. 4 is a schematic block diagram illustrating a configuration of the terminal apparatus 1 according to the present embodiment. As illustrated, the terminal apparatus 1 includes a radio transmission and/or reception unit 10 and a higher layer processing unit 14. The radio transmission and/or reception unit 10 includes an antenna unit 11, a Radio Frequency (RF) unit 12, and a baseband unit 13. The higher layer processing unit 14 includes a medium access control layer processing unit 15 and a radio resource control layer processing unit 16. The radio transmission and/or reception unit 10 is also referred to as a transmitter, a receiver, a coding unit, a decoding unit, or a physical layer processing unit.

The higher layer processing unit 14 outputs uplink data (transport block) generated by a user operation or the like, to the radio transmission and/or reception unit 10. The higher layer processing unit 14 performs processing of the Medium Access Control (MAC) layer, the Packet Data Convergence Protocol (PDCP) layer, the Radio Link Control (RLC) layer, and the Radio Resource Control (RRC) layer.

The medium access control layer processing unit 15 included in the higher layer processing unit 14 performs processing of the Medium Access Control layer.

The medium access control layer processing unit 15 controls random access procedure in accordance with various types of configuration information/parameters managed by the radio resource control layer processing unit 16.

The radio resource control layer processing unit 16 included in the higher layer processing unit 14 performs processing of the Radio Resource Control layer. The radio resource control layer processing unit 16 manages various types of configuration information/parameters of the terminal apparatus 1. The radio resource control layer processing unit 16 sets various types of configuration information/parameters based on a higher layer signaling received from the base station apparatus 3. Namely, the radio resource control layer processing unit 16 sets the various configuration information/parameters in accordance with the information for indicating the various configuration information/parameters received from the base station apparatus 3.

The radio transmission and/or reception unit 10 performs processing of the physical layer, such as modulation, demodulation, coding, decoding, and the like. The radio transmission and/or reception unit 10 demultiplexes, demodulates, and decodes a signal received from the base station apparatus 3, and outputs the information resulting from the decoding to the higher layer processing unit 14. The radio transmission and/or reception unit 10 generates a transmit signal by modulating and coding data, and performs transmission to the base station apparatus 3.

The RF unit 12 converts (down-converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the digital signal resulting from the conversion, performs Fast Fourier Transform (FFT) of the signal from which the CP has been removed, and extracts a signal in the frequency domain.

The baseband unit 13 generates an SC-FDMA symbol by performing Inverse Fast Fourier Transform (IFFT) of the data, adds CP to the generated SC-FDMA symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 by using a low-pass filter, up-converts the analog signal into a signal of a carrier frequency, and transmits the up-converted signal via the antenna unit 11. Furthermore, the RF unit 12 amplifies power. Furthermore, the RF unit 12 may have a function of controlling transmit power. The RF unit 12 is also referred to as a transmit power control unit.

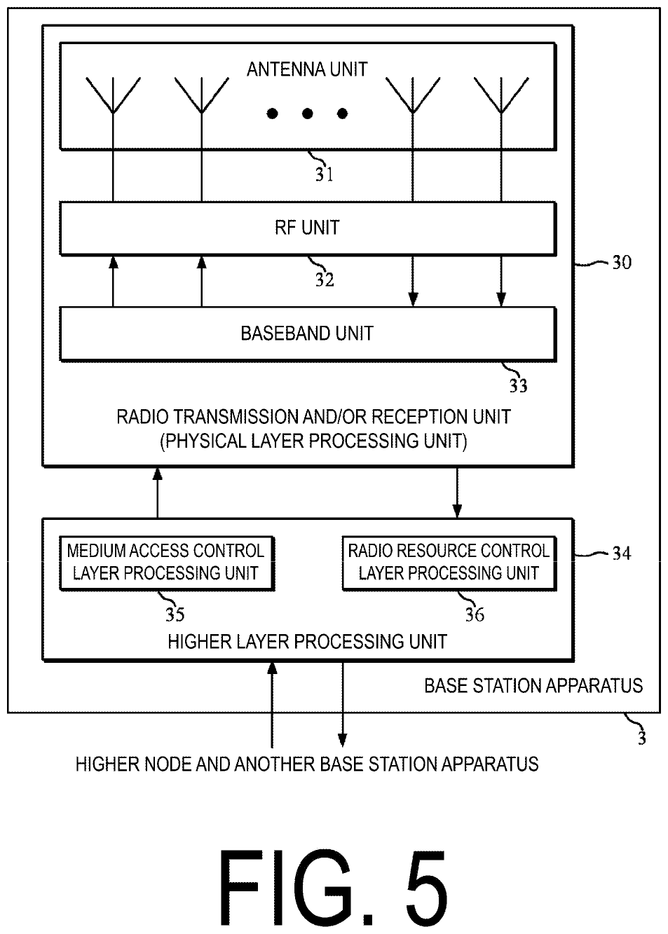

FIG. 5 is a schematic block diagram illustrating a configuration of the base station apparatus 3 according to the present embodiment. As illustrated, the base station apparatus 3 includes a radio transmission and/or reception unit 30 and a higher layer processing unit 34. The radio transmission and/or reception unit 30 includes an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver, a coding unit, a decoding unit, or a physical layer processing unit.

The higher layer processing unit 34 performs processing of the Medium Access Control (MAC) layer, the Packet Data Convergence Protocol (PDCP) layer, the Radio Link Control (RLC) layer, and the Radio Resource Control (RRC) layer.

The medium access control layer processing unit 35 included in the higher layer processing unit 34 performs processing of the Medium Access Control layer. The medium access control layer processing unit 35 controls random access procedure in accordance with various types of configuration information/parameters managed by the radio resource control layer processing unit 36.

The radio resource control layer processing unit 36 included in the higher layer processing unit 34 performs processing of the Radio Resource Control layer. The radio resource control layer processing unit 36 generates, or acquires from a higher node, downlink data (transport block) allocated on a physical downlink shared channel, system information, an RRC message, a MAC Control Element (CE), and the like, and performs output to the radio transmission and/or reception unit 30. Furthermore, the radio resource control layer processing unit 36 manages various types of configuration information/parameters for each of the terminal apparatuses 1. The radio resource control layer processing unit 36 may set various types of configuration information/parameters for each of the terminal apparatuses 1 via higher layer signaling. That is, the radio resource control layer processing unit 36 transmits/reports information indicating various types of configuration information/parameters.

The functionality of the radio transmission and/or reception unit 30 is similar to the functionality of the radio transmission and/or reception unit 10, and hence description thereof is omitted.

Each of the units having the reference signs 10 to 16 included in the terminal apparatus 1 may be configured as a circuit. Each of the units having the reference signs 30 to 36 included in the base station apparatus 3 may be configured as a circuit. Each of the units that are included in the terminal apparatus 1 and have the reference signs 10 to 16 may be configured as at least one processor and a memory coupled to the at least one processor. Each of the units that are included in the base station apparatus 3 and have the reference signs 30 to 36 may be configured as at least one processor and a memory coupled to the at least one processor.

A band width part (BWP) will be described below.

The BWP is defined by one or multiple continuous physical resource blocks in the frequency domain.

For one serving cell, one or multiple downlink BWPs and one or multiple uplink BWPs may be configured.

One or multiple downlink BWPs include at least one initial downlink BWP. One or multiple uplink BWPs include at least one initial uplink BWP. An index of the initial downlink BWP and an index of the initial uplink BWP are 0. The terminal apparatus 1 may receive a higher layer parameter indicating the initial downlink BWP.

In one serving cell, up to one downlink BWP is simultaneously activated out of the one or multiple downlink BWPs. In one serving cell, up to one uplink BWP is simultaneously activated out of the one or multiple uplink BWPs. The terminal apparatus 1 may switch an activated downlink BWP and/or an activated uplink BWP, based on an RRC parameter and/or the PDCCH. In the uplink and the downlink, to switch activated BWPs is to simultaneously perform activation of a deactivated BWP and deactivation of an activated BWP.

The terminal apparatus 1 may perform monitoring of the PDCCH and reception of the PDSCH (DL-SCH) in the activated downlink BWP. The terminal apparatus 1 does not perform monitoring of the PDCCH and reception of the PDSCH (DL-SCH) in the deactivated downlink BWP. To perform monitoring may be to attempt decoding of the PDCCH according to the DCI format.

The terminal apparatus 1 may perform transmission of the PUSCH (UL-SCH), transmission of the PUCCH, and transmission of an SRS in the activated uplink BWP. The terminal apparatus 1 does not perform transmission of the PUSCH (UL-SCH), transmission of the PUCCH, and transmission of the SRS in the deactivated uplink BWP.

The activated downlink BWP is also referred to as an active downlink BWP. The activated uplink BWP is also referred to as an active uplink BWP.

A control resource set (CORESET) will be described below. The CORESET according to the present embodiment is included in the activated downlink BWP.

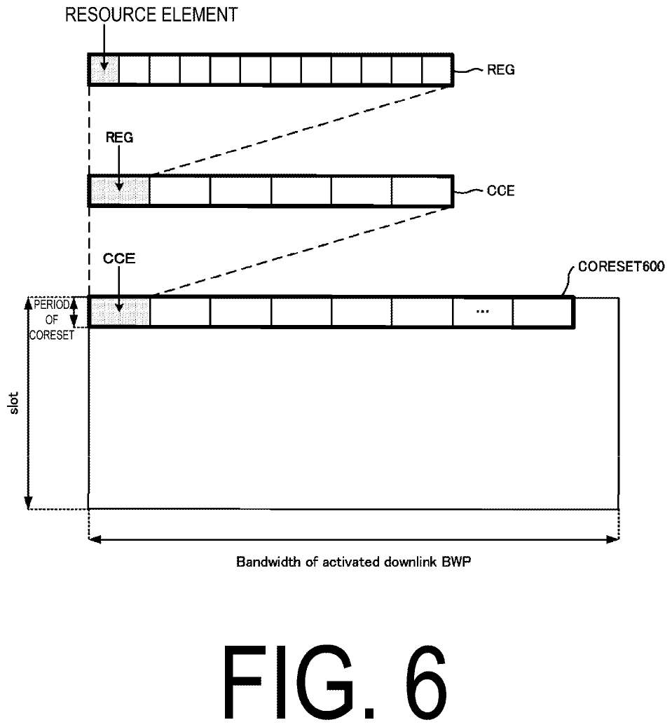

FIG. 6 is a diagram illustrating an example of the CORESET according to the present embodiment. In the present embodiment, the CORESET is included in one BWP. In the time domain, a period of the CORESET in one PDCCH monitoring occasion is 1, 2, or 3 OFDM symbols. The PDCCH monitoring occasion is a set of OFDM symbols in which monitoring of the CORESET is configured. The CORESET may include multiple Control Channel Elements (CCEs). The CORESET may include multiple continuous resource elements in the frequency domain. One CCE may include six continuous Resource Element Groups (REGs) in the frequency domain. The six REGs constituting one CCE may not be continuous in the frequency domain. One REG may include 12 continuous resource elements in the frequency domain. In a case that the CCE corresponding to the CORESET includes six continuous REGs in the frequency domain, the CORESET is also referred to as a non-interleaved CORESET. In a case that the six REGs constituting the CCE corresponding to the CORESET are not continuous in the frequency domain, the CORESET is also referred to as an interleaved CORESET.

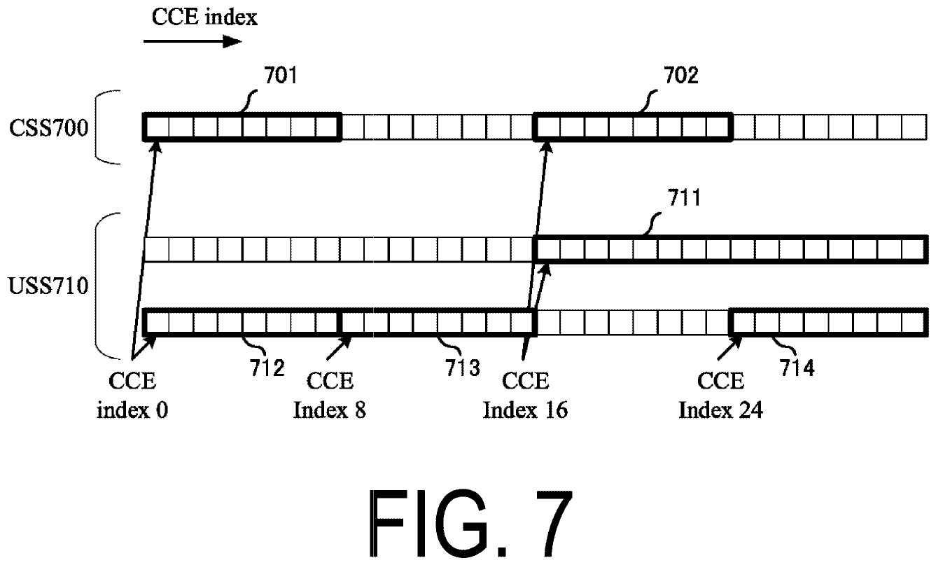

FIG. 7 is a diagram illustrating an example of search spaces according to the present embodiment. The search space is a set of PDCCH candidates. The PDCCH is transmitted in the PDCCH candidate. The terminal apparatus 1 attempts decoding of the

PDCCH in the search space. The PDCCH candidate may include one or multiple CCEs. The number of CCEs constituting the PDCCH candidate is also referred to as an aggregation level.

A search space 700 is a Common Search Space (CSS). A search space 710 is a UE-specific Search Space (USS). The CSS 700 and the USS 710 are included in one CORESET. The PDCCH candidates included in the USS 710 may be given based on at least a prescribed RNTI. Here, the prescribed RNTI may be a Cell Radio Network Temporary Identifier (C-RNTI). The PDCCH candidates included in the CSS 700 may be given regardless of the prescribed RNTI.

The CSS 700 includes two PDCCH candidates 701 and 702 having the aggregation level of 8. The USS 710 includes one PDCCH candidate 711 having the aggregation level of 16, and three PDCCH candidates 712, 713, and 714 having the aggregation level of 8.

The set of CCEs constituting the PDCCH candidate 701 is the same as the set of CCEs constituting the PDCCH candidate 712. The set of CCEs constituting the PDCCH candidate 702 is different from the set of CCEs constituting the PDCCH candidate 711, but the CCE having the lowest index constituting the PDCCH candidate 702 is the same as the CCE having the lowest index constituting the PDCCH candidate 711.

The DCI format according to the present embodiment will be described below. In the present embodiment, the size of the DCI format is also referred to as a DCI size or a payload size of the DCI format.

DCI format 0_0 according to the present embodiment will be described.

DCI format 0_0 may be used for scheduling of the PUSCH in a single cell. DCI format 0_0 according to the present embodiment is DCI format 0_0 accompanied with a CRC that is scrambled with the C-RNTI. DCI format 0_0 includes at least the following fields.
‘Identifier for DCI formats’ field—1 bit
‘Frequency domain resource assignment’ field—N_{FDRA0_0} bits—‘Time domain resource assignment’ field—4 bits
‘Frequency hopping flag’ field—1 bit
‘Modulation and coding scheme’ field—5 bits
‘New data indicator’ field—1 bit
‘Redundancy version’ field—2 bits
‘HARQ process number’ field—4 bits
‘TPC command for scheduled PUSCH’ field—2 bits
‘UL/SUL indicator’ field—0 or 1 bit

The size N_{FDRA0_0} of the ‘Frequency domain resource assignment’ field of DCI format 0_0 may be given according to the following equation (1). The size of the ‘UL/SUL indicator’ field may be given at least based on the higher layer parameter. In the following, in the present embodiment, the size of the ‘UL/SUL indicator’ field is 0 bits. The size of the field of DCI format 0_0 other than the ‘Frequency domain resource assignment’ field and the ‘UL/SUL indicator’ field is defined in a specification in advance.

N_{FDRA0_0}=ceil(log₂(N^{UL,BWP}(N^{UL,BWP}+1)/2)) [Equation 1]
N^{UL,BWP} is the size of the active UL BWP in a case that DCI format 0_0 is monitored in the USS and satisfying
   (condition A) the total number of different DCI sizes monitored per slot is no more than X_{A} for the cell, and
   (condition B) the total number of different DCI sizes with C-RNTI monitored per slot is no more than X_{B} for the cell
otherwise, N^{UL,BWP} is the size of the initial UL BWP.

N^{UL,BWP} is represented by the number of resource blocks. N^{UL,BWP} is the size of the initial uplink BWP, or the size of the active uplink BWP.

In a case that the condition A and the condition B are satisfied and DCI format 0_0 is monitored in the USS, N^{UL,BWP} may be the size of the active uplink BWP. Otherwise, N^{UL,BWP} may be the size of the initial uplink BWP.

In a case that the condition A or the condition B is not satisfied or DCI format 0_0 is monitored in the CSS, N^{UL,BWP} may be the size of the initial uplink BWP. Otherwise, N^{UL,BWP} may be the size of the active uplink BWP.

The condition A may be a condition that a total number of different DCI sizes monitored for each slot is not larger than X_{A} for a cell (the total number of different DCI sizes monitored per slot is no more than 4 for the cell). Here, the value of X_{A} may be 4, or a value larger than 4.

The condition B may be a condition that a total number of different DCI sizes accompanied with the C-RNTI monitored for each slot is not larger than X_{B} for a cell (the total number of different DCI sizes with C-RNTI monitored per slot is no more than 3 for the cell). Here, the value of X_{B} may be 3, or a value larger than 3. The value of X_{B} may be the same as or smaller than the value of X_{A}.

DCI format 1_0 according to the present embodiment will be described.

In a case that the ‘Frequency domain resource assignment’ field of DCI format 1_0 is not set to all 1, DCI format 1_0 may be used for scheduling of the PDSCH in a single cell. The ‘Frequency domain resource assignment’ field of DCI format 1_0 according to the present embodiment is not set to all 1. Specifically, DCI format 1_0 according to the present embodiment may be used for scheduling of the PDSCH in a single cell.

DCI format 1_0 according to the present embodiment is DCI format 0_0 accompanied with the CRC that is scrambled with the C-RNTI.

DCI format 1_0 includes the following fields.
‘Identifier for DCI formats’ field—1 bit
‘Frequency domain resource assignment’ field—N_{FDRA1_0} bits—‘Time domain resource assignment’ field—4 bits
‘VRB-to-PRB mapping’ field—1 bit
‘Modulation and coding scheme’ field—5 bits
‘New data indicator’ field—1 bit
‘Redundancy version’ field—2 bits
‘HARQ process number’ field—4 bits
‘Downlink assignment index’ field—2 bits
‘TPC command for scheduled PUCCH’ field—2 bits
‘PUCCH resource indicator’ field—3 bits
‘PDSCH-to-HARQ feedback timing indicator’ field—3 bits

The size N_{FDRA1_0} of the ‘Frequency domain resource assignment’ field of DCI format 1_0 may be given according to the following equation (2). The size of the field of DCI format 1_0 other than the ‘Frequency domain resource assignment’ field is defined in a specification in advance.

N_{FDRA1_0}=ceil(log₂(N^{DL,BWP}(N^{DL,BWP}+1)/2)) [Equation 2]
N^{DL,BWP} is the size of the active DL BWP in a case that DCI format 1_0 is monitored in the USS and satisfying
   (condition A) the total number of different DCI sizes monitored per slot is no more than X_{A} for the cell, and
   (condition B) the total number of different DCI sizes with C-RNTI monitored per slot is no more than X_{B} for the cell
otherwise, N^{DL,BWP} is the size of the certain band X.

N^{DL, BWP} is represented by the number of resource blocks. N^{DL,BWP} is the size of the active downlink BWP, or the size of a prescribed band X. Here, the prescribed band X may be the initial downlink BWP, or a prescribed CORESET. Here, the prescribed CORESET may be a CORESET in which DCI format 1_0 is monitored, or a CORESET of a prescribed index. The prescribed index may be a value (for example, 0) that is determined in advance. The prescribed index may be given by the RRC parameter. The initial downlink BWP may be different from the band of the prescribed CORESET.

In a case that the condition A and the condition B are satisfied and DCI format 1_0 is monitored in the USS, N^{DL,BWP} may be the size of the active downlink BWP. Otherwise, N^{UL,BWP} may be the size of the prescribed band X.

In a case that the condition A or the condition B is not satisfied or DCI format 0_0 is monitored in the CSS, N^{DL,BWP} may be the size of the prescribed band X. Otherwise, N^{DL,BWP} may be the size of the active downlink BWP.

The size of DCI format 0_0 monitored in the CSS for scheduling the serving cell (DCI format 0_0 monitored in CSS for scheduling a serving cell) is the same as the size of DCI format 1_0 monitored in the USS for scheduling the same serving cell (DCI format 1_0 monitored in CSS for scheduling the serving cell).

In a case that DCI format 0_0 for scheduling the serving cell is monitored in the CSS, and the number of information bits in the same DCI format 0_0 before padding or truncation (the DCI format 0_0 prior to padding or truncating) is smaller than the size of DCI format 1_0 monitored in the CSS for scheduling the same serving cell, one or multiple bits are added to DCI format 0_0 until the size of DCI format 0_0 becomes the same as the size of DCI format 1_0. Here, the one or multiple bits are set to 0.

In a case that DCI format 0_0 for scheduling the serving cell is monitored in the CSS, and the number of information bits in the same DCI format 0_0 before padding or truncation (the DCI format 0_0 prior to padding or truncating) is larger than the size of DCI format 1_0 monitored in the CSS for scheduling the same serving cell, the bit width of the ‘Frequency domain resource assignment’ field of DCI format 0_0 is reduced by truncating first one or multiple Most Significant Bits (MSBs) of the ‘Frequency domain resource assignment’ field so that the size of DCI format 0_0 and the size of DCI format 1_0 become the same.

The size of DCI format 0_0 monitored in the USS for scheduling the serving cell (DCI format 0_0 monitored in USS for scheduling a serving cell) is the same as the size of the DCI format 1_0 monitored in the USS for scheduling the same serving cell (DCI format 1_0 monitored in USS for scheduling the serving cell).

In a case that DCI format 0_0 for scheduling the serving cell is monitored in the USS, at east one of the condition A and the condition B is not satisfied, and the number of information bits in the same DCI format 0_0 before padding or truncation (the DCI format 0_0 prior to padding or truncating) is smaller than the size of DCI format 1_0 monitored in the USS for scheduling the same serving cell, one or multiple bits are added to DCI format 0_0 until the size of DCI format 0_0 becomes the same as the size of DCI format 1_0. Here, the one or multiple bits are set to 0.

In a case that DCI format 0_0 for scheduling the serving cell is monitored in the USS, at least one of the condition A and the condition B is not satisfied, and the number of information bits in the same DCI format 0_0 before padding or truncation (the DCI format 0_0 prior to padding or truncating) is larger than the size of DCI format 1_0 monitored in the USS for scheduling the same serving cell, the bit width of the ‘Frequency domain resource assignment’ field of DCI format 0_0 is reduced by truncating first one or multiple Most Significant Bits (MSBs) of the ‘Frequency domain resource assignment’ field so that the size of DCI format 0_0 and the size of DCI format 1_0 become the same.

In a case that DCI format 0_0 for scheduling the serving cell is monitored in the USS, both of the condition A and the condition B are satisfied, and the number of information bits in the same DCI format 0_0 before padding or truncation (the DCI format 0_0 prior to padding or truncating) is smaller than the size of DCI format 1_0 monitored in the USS for scheduling the same serving cell, one or multiple bits are added to DCI format 0_0 until the size of DCI format 0_0 becomes the same as the size of DCI format 1_0. Here, the one or multiple bits are set to 0.

In a case that DCI format 0_0 for scheduling the serving cell is monitored in the USS, both of the condition A and the condition B are satisfied, and the number of information bits in the same DCI format 0_0 before padding or truncation (the DCI format 0_0 prior to padding or truncating) is larger than the size of DCI format 1_0 monitored in the USS for scheduling the same serving cell, the size of the DCI format 0_0 is the same as the number of information bits in the same DCI format 0_0 before padding or truncation (the DCI format 0_0 prior to padding or truncating).

In a case that DCI format 1_0 for scheduling the serving cell is monitored in the USS, both of the condition A and the condition B are satisfied, and the number of information bits in the DCI format 1_0 before padding (the DCI format 1_0 prior to padding) is smaller than the size of DCI format 0_0 monitored in the USS for scheduling the same serving cell, one or multiple bits are added to DCI format 1_0 until the size of DCI format 1_0 becomes the same as the size of DCI format 0_0. Here, the one or multiple bits are set to 0.

The terminal apparatus 1 can identify DCI format 0_0 and DCI format 1_0 by using the ‘Identifier for DCI formats’ field. The ‘Identifier for DCI formats’ field of DCI format 0_0 is set to 0. The ‘Identifier for DCI formats’ field of DCI format 1_0 is set to 1.

DCI format 0_1 according to the present embodiment will be described.

DCI format 0_1 may be used for scheduling of the PUSCH in a single cell. Unless otherwise specifically noted, DCI format 0_1 according to the present embodiment is DCI format 0_1 accompanied with the CRC that is scrambled with the C-RNTI. A set of fields included in DCI format 0_1 is different from the set of fields included in DCI format 0_0.

DCI format 1_1 according to the present embodiment will be described.

DCI format 1_1 may be used for scheduling of the PDSCH in a single cell. Unless otherwise specifically noted, DCI format 1_1 according to the present embodiment is DCI format 1_1 accompanied with the CRC that is scrambled with the C-RNTI. A set of fields included in DCI format 1_1 is different from a set of fields included in DCI format 1_0.

DCI format 0_1 and DCI format 1_1 are monitored only in the USS out of the CSS and the USS. DCI format 0_1 and DCI format 1_1 are not monitored in the CSS.

The size of DCI format 0_1 for scheduling the serving cell is different from any of the size of DCI format 0_0 monitored in the CSS for scheduling the same serving cell, the size of DCI format 1_0 monitored in the CSS for scheduling the same serving cell, the size of DCI format 0_0 monitored in the USS for scheduling the same serving cell, and the size of DCI format 1_0 monitored in the USS for scheduling the same serving cell.

In a case that the number of information bits of DCI format 0_1 before padding for scheduling the serving cell is the same as any of the size of DCI format 0_0 monitored in the CSS for scheduling the same serving cell, the size of DCI format 1_0 monitored in the CSS for scheduling the same serving cell, the size of DCI format 0_0 monitored in the USS for scheduling the same serving cell, and the size of DCI format 1_0 monitored in the USS for scheduling the same serving cell, one or multiple bits may be added to DCI format 0_1 so that the size of the DCI format 0_1 becomes different from all of the size of DCI format 0_0 monitored in the CSS for scheduling the same serving cell, the size of DCI format 1_0 monitored in the CSS for scheduling the same serving cell, the size of DCI format 0_0 monitored in the USS for scheduling the same serving cell, and the size of DCI format 1_0 monitored in the USS for scheduling the same serving cell. Here, the one or multiple bits are set to 0.

In a case that the number of information bits of DCI format 0_1 before padding for scheduling the serving cell is the same as any of the size of DCI format 0_0 monitored in the CSS for scheduling the same serving cell and the size of DCI format 0_0 monitored in the USS for scheduling the same serving cell, one or multiple bits may be added to DCI format 0_1 so that the size of the DCI format 0_1 becomes different from both of the size of DCI format 0_0 monitored in the CSS for scheduling the same serving cell and the size of DCI format 0_0 monitored in the USS for scheduling the same serving cell. Here, the one or multiple bits are set to 0.

In a case that the number of information bits of DCI format 0_1 before padding for scheduling the serving cell is the same as any of the size of DCI format 1_0 monitored in the CSS for scheduling the same serving cell and the size of DCI format 1_0 monitored in the USS for scheduling the same serving cell, one or multiple bits may be added to DCI format 0_1 so that the size of the DCI format 0_1 becomes different from both of the size of DCI format 1_0 monitored in the CSS for scheduling the same serving cell and the size of DCI format 1_0 monitored in the USS for scheduling the same serving cell. Here, the one or multiple bits are set to 0.

In a case that the number of information bits of DCI format 0_1 before padding for scheduling the serving cell is the same as any of the size of DCI format 0_0 derived from the size of the initial uplink BWP for scheduling the same serving cell, the size of DCI format 1_0 derived from the prescribed band X for scheduling the same serving cell, the size of DCI format 0_0 derived from the size of the active uplink BWP for scheduling the same serving cell, and the size of DCI format 1_0 derived from the size of the active downlink BWP for scheduling the same serving cell, one or multiple bits may be added to DCI format 0_1 until the size of the DCI format 0_1 becomes different from all of the size of DCI format 0_0 derived from the size of the initial uplink BWP for scheduling the same serving cell, the size of DCI format 1_0 derived from the prescribed band X for scheduling the same serving cell, the size of DCI format 0_0 derived from the size of the active uplink BWP for scheduling the same serving cell, and the size of DCI format 1_0 derived from the size of the active downlink BWP for scheduling the same serving cell. Here, the one or multiple bits are set to 0.

In a case that the number of information bits of DCI format 0 1 before padding for scheduling the serving cell is the same as any of the size of DCI format 0_0 derived from the size of the initial uplink BWP for scheduling the same serving cell and the size of DCI format 0_0 derived from the size of the active uplink BWP for scheduling the same serving cell, one or multiple bits may be added to DCI format 0_1 until the size of the DCI format 0_1 becomes different from both of the size of DCI format 0_0 derived from the size of the initial uplink BWP for scheduling the same serving cell and the size of DCI format 0_0 derived from the size of the active uplink BWP for scheduling the same serving cell. Here, the one or multiple bits are set to 0.

In a case that the number of information bits of DCI format 0_1 before padding for scheduling the serving cell is the same as any of the size of DCI format 1_0 derived from the prescribed band X for scheduling the same serving cell and the size of DCI format 1_0 derived from the size of the active downlink BWP for scheduling the same serving cell, one or multiple bits may be added to DCI format 0_1 until the size of the DCI format 0_1 becomes different from both of the size of DCI format 1_0 derived from the prescribed band X for scheduling the same serving cell and the size of DCI format 1_0 derived from the size of the active downlink BWP for scheduling the same serving cell. Here, the one or multiple bits are set to 0.

In a case that the number of information bits of DCI format 0_1 before padding for scheduling the serving cell is the same as any of the size of DCI format 1_0 derived from the initial downlink BWP for scheduling the same serving cell, the size of DCI format 1_0 derived from the above-described prescribed CORESET for scheduling the same serving cell, and the size of DCI format 1_0 derived from the size of the active downlink BWP for scheduling the same serving cell, one or multiple bits may be added to DCI format 0_1 until the size of the DCI format 1_1 becomes different from all of the size of DCI format 1_0 derived from the initial downlink BWP for scheduling the same serving cell, the size of DCI format 1_0 derived from the above-described prescribed CORESET for scheduling the same serving cell, and the size of DCI format 1_0 derived from the size of the active downlink BWP for scheduling the same serving cell. Here, the one or multiple bits are set to 0.

The size of DCI format 1_1 for scheduling the serving cell is different from all of the size of DCI format 0_0 monitored in the CSS for scheduling the same serving cell, the size of DCI format 1_0 monitored in the CSS for scheduling the same serving cell, the size of DCI format 0_0 monitored in the USS for scheduling the same serving cell, and the size of DCI format 1_0 monitored in the USS for scheduling the same serving cell.

In a case that the number of information bits of DCI format 1_1 before padding for scheduling the serving cell is the same as any of the size of DCI format 0_0 monitored in the CSS for scheduling the same serving cell, the size of DCI format 1_0 monitored in the CSS for scheduling the same serving cell, the size of DCI format 0_0 monitored in the USS for scheduling the same serving cell, and the size of DCI format 1_0 monitored in the USS for scheduling the same serving cell, one or multiple bits may be added to DCI format 1_1 until the size of the DCI format 1_1 becomes different from all of the size of DCI format 0_0 monitored in the CSS for scheduling the same serving cell, the size of DCI format 1_0 monitored in the CSS for scheduling the same serving cell, the size of DCI format 0_0 monitored in the USS for scheduling the same serving cell, and the size of DCI format 1_0 monitored in the USS for scheduling the same serving cell. Here, the one or multiple bits are set to 0.

In a case that the number of information bits of DCI format 1_1 before padding for scheduling the serving cell is the same as any of the size of DCI format 0_0 monitored in the CSS for scheduling the same serving cell and the size of DCI format 0_0 monitored in the USS for scheduling the same serving cell, one or multiple bits may be added to DCI format 1_1 until the size of the DCI format 1_1 becomes different from both of the size of DCI format 0_0 monitored in the CSS for scheduling the same serving cell and the size of DCI format 0_0 monitored in the USS for scheduling the same serving cell. Here, the one or multiple bits are set to 0.

In a case that the number of information bits of DCI format 1_1 before padding for scheduling the serving cell is the same as any of the size of DCI format 1_0 monitored in the CSS for scheduling the same serving cell and the size of DCI format 1_0 monitored in the USS for scheduling the same serving cell, one or multiple bits may be added to DCI format 1_1 until the size of the DCI format 1_1 becomes different from both of the size of DCI format 1_0 monitored in the CSS for scheduling the same serving cell and the size of DCI format 1_0 monitored in the USS for scheduling the same serving cell. Here, the one or multiple bits are set to 0.

In a case that the number of information bits of DCI format 1_1 before padding for scheduling the serving cell is the same as any of the size of DCI format 0_0 derived from the size of the initial uplink BWP for scheduling the same serving cell, the size of DCI format 1_0 derived from the prescribed band X for scheduling the same serving cell, the size of DCI format 0_0 derived from the size of the active uplink BWP for scheduling the same serving cell, and the size of DCI format 1_0 derived from the size of the active downlink BWP for scheduling the same serving cell, one or multiple bits may be added to DCI format 1_1 until the size of the DCI format 1_1 becomes different from all of the size of DCI format 0_0 derived from the size of the initial uplink BWP for scheduling the same serving cell, the size of DCI format 1_0 derived from the prescribed band X for scheduling the same serving cell, the size of DCI format 0_0 derived from the size of the active uplink BWP for scheduling the same serving cell, and the size of DCI format 1_0 derived from the size of the active downlink BWP for scheduling the same serving cell. Here, the one or multiple bits are set to 0.

In a case that the number of information bits of DCI format 1_1 before padding for scheduling the serving cell is the same as any of the size of DCI format 0_0 derived from the size of the initial uplink BWP for scheduling the same serving cell and the size of DCI format 0_0 derived from the size of the active uplink BWP for scheduling the same serving cell, one or multiple bits may be added to DCI format 1_1 until the size of the DCI format 1_1 becomes different from both of the size of DCI format 0_0 derived from the size of the initial uplink BWP for scheduling the same serving cell and the size of DCI format 0_0 derived from the size of the active uplink BWP for scheduling the same serving cell. Here, the one or multiple bits are set to 0.

In a case that the number of information bits of DCI format 1_1 before padding for scheduling the serving cell is the same as any of the size of DCI format 1_0 derived from the prescribed band X for scheduling the same serving cell and the size of DCI format 1_0 derived from the size of the active downlink BWP for scheduling the same serving cell, one or multiple bits may be added to DCI format 1_1 until the size of the DCI format 1_1 becomes different from both of the size of DCI format 1_0 derived from the prescribed band X for scheduling the same serving cell and the size of DCI format 1_0 derived from the size of the active downlink BWP for scheduling the same serving cell. Here, the one or multiple bits are set to 0.

In a case that the number of information bits of DCI format 1_1 before padding for scheduling the serving cell is the same as any of the size of DCI format 1_0 derived from the initial downlink BWP for scheduling the same serving cell, the size of DCI format 1_0 derived from the above-described prescribed CORESET for scheduling the same serving cell, and the size of DCI format 1_0 derived from the size of the active downlink BWP for scheduling the same serving cell, one or multiple bits may be added to DCI format 1_1 until the size of the DCI format 1_1 becomes different from all of the size of DCI format 1_0 derived from the initial downlink BWP for scheduling the same serving cell, the size of DCI format 1_0 derived from the above-described prescribed CORESET for scheduling the same serving cell, and the size of DCI format 1_0 derived from the size of the active downlink BWP for scheduling the same serving cell. Here, the one or multiple bits are set to 0.

The size of DCI format 0_1 for scheduling the serving cell may be the same as or different from the size of DCI format 1_1 for scheduling the same serving cell.

In a case that the size of DCI format 0_1 for scheduling the serving cell is the same as the size of DCI format 1_1 for scheduling the same serving cell, the terminal apparatus 1 can identify DCI format 0_1 and DCI format 1_1 by using the ‘Identifier for DCI formats’ field. The ‘Identifier for DCI formats’ field of DCI format 0_1 is set to 0. The ‘Identifier for DCI formats’ field of DCI format 1_0 is set to 1.

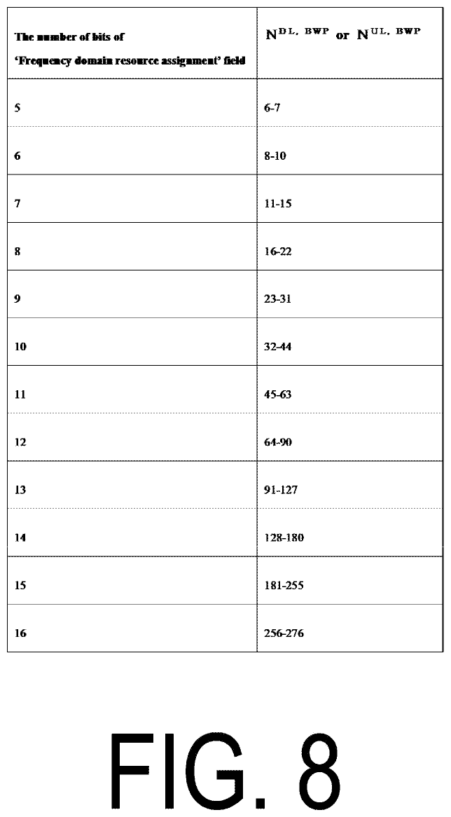

FIG. 8 is a diagram illustrating correspondence between the ‘Frequency domain resource assignment’ field and N^{DL,BWP} and N^{UL,BWP} according to the present embodiment. For example, in a case that the prescribed size X is 6, the number of bits of the ‘Frequency domain resource assignment’ field derived from the prescribed size X is 5.

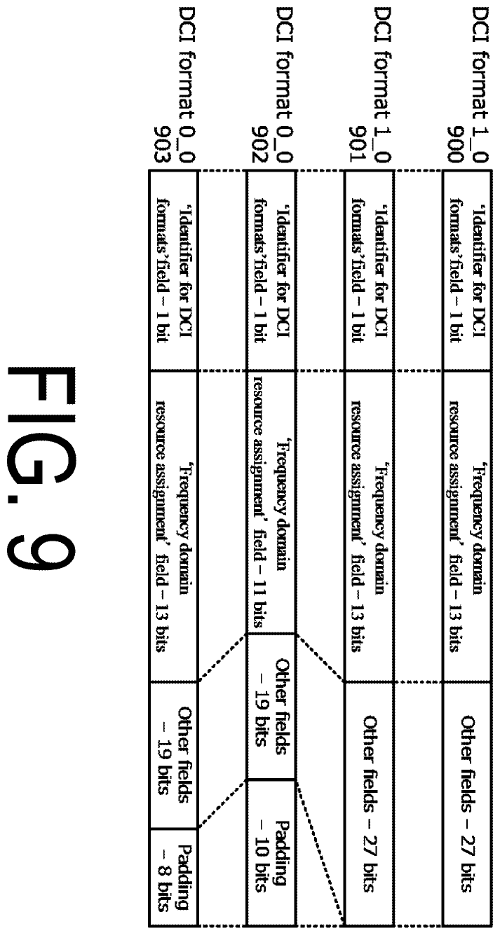

FIG. 9 is a diagram illustrating an example of DCI format 0_0 and DCI format 1_0 according to the present embodiment. 900 represents DCI format 1_0 derived from the size of the prescribed band X. 901 represents DCI format 1_0 derived from the size of the active downlink BWP. 902 represents DCI format 0_0 derived from the size of the initial uplink BWP. 903 represents DCI format 0_0 derived from the size of the active uplink BWP.

The size of the ‘Frequency domain resource assignment’ field in 900, the size of the ‘Frequency domain resource assignment’ field in 901, and the size of the ‘Frequency domain resource assignment’ field in 903 are 13 bits. The size of the ‘Frequency domain resource assignment’ field in 902 is 11 bits.

The DCI format of 900 is the same as the DCI format of 901, and a set of fields of the DCI format of 900 is the same as a set of fields of the DCI format of 901. The DCI format of 902 is the same as the DCI format of 903, and a set of fields of the DCI format of 902 is different from a set of fields of the DCI format of 903. A case that the first set of fields is the same as the second set of fields means that the type and the size of the n-th field included in the first set of fields are the same as the type and the size of the n-th field included in the second set of fields (n=1, 2, 3, . . . ).

Even in a case that the size of the initial uplink BWP and the size of the active uplink BWP are different from each other, the number of bits of the ‘Frequency domain resource assignment’ field derived from the size of the initial uplink BWP may be the same as the number of bits of the ‘Frequency domain resource assignment’ field derived from the size of the active uplink BWP. Specifically, even in a case that the size of the initial uplink BWP and the size of the active uplink BWP are different from each other, a set of fields of DCI format 0_0 derived from the size of the initial uplink BWP may be the same as a set of fields of DCI format 0_0 derived from the size of the active uplink BWP.

For example, in a case that the size of the initial uplink BWP is 96 and the size of the active uplink BWP is 127, the number of bits of the ‘Frequency domain resource assignment’ field derived from the size of the initial uplink BWP is the same as the number of bits of the ‘Frequency domain resource assignment’ field derived from the size of the active uplink BWP.

Even in a case that the size of the prescribed band X and the size of the active downlink BWP are different from each other, the number of bits of the ‘Frequency domain resource assignment’ field derived from the size of the prescribed band X may be the same as the number of bits of the ‘Frequency domain resource assignment’ field derived from the size of the active downlink BWP. Specifically, even in a case that the size of the prescribed band X and the size of the active downlink BWP are different from each other, a set of fields of DCI format 1_0 derived from the size of the prescribed band X may be the same as a set of fields of DCI format 1_0 derived from the size of the active downlink BWP.

For example, in a case that the size of the prescribed band X is 96 and the size of the active downlink BWP is 127, the number of bits of the ‘Frequency domain resource assignment’ field derived from the size of the prescribed band X is the same as the number of bits of the ‘Frequency domain resource assignment’ field derived from the size of the active downlink BWP.

DCI format 2_0 is used to report a slot format. The size of DCI format 2_0 is configured by using the higher layer parameter. DCI format 2_0 according to the present embodiment is DCI format 2_0 accompanied with the CRC that is scrambled with an SFI-RNTI.

The size of DCI format 2_0 may be the same as or different from the size of other DCI formats. In a case that the size of DCI format 2_0 is the same as the size of other DCI formats, the terminal apparatus 1 can identify DCI format 2_0 by using the SFI-RNTI.

DCI format 2_1 is used to report the physical resource block and the OFDM symbol in which the terminal apparatus 1 may assume there is no transmission for the terminal apparatus 1 (the physical resource block(s) and OFDM symbol(s) where terminal device 1 may assume no transmission is intended for the UE). The size of DCI format 2_1 is configured by using the higher layer parameter. DCI format 2_1 according to the present embodiment is DCI format 2_1 accompanied with the CRC that is scrambled with an INT-RNTI.

The size of DCI format 2_1 may be the same as or different from the size of other DCI formats. In a case that the size of DCI format 2_1 is the same as the size of other DCI formats, the terminal apparatus 1 can identify DCI format 2_1 by using the INT-RNTI.

The ‘Frequency domain resource assignment’ field of DCI format 0_0 includes a Resource Indication Value (RIV). The RIV included in the ‘Frequency domain resource assignment’ field of DCI format 0_0 is also referred to as RIV 0_0.

Calculation of RIV 0_0 in the base station apparatus 3 is performed based on a type (the CSS or the USS) of the search space in which DCI format 0_0 is transmitted. Interpretation of RIV 0_0 in the terminal apparatus 1 is performed based on a type (the CSS or the USS) of the search space in which DCI format 0_0 is transmitted.

RIV 0_0 may indicate resource block assignment information. The resource block assignment information of RIV 0_0 indicates, for the scheduled terminal apparatus 1, a set of contiguously allocated Virtual Resource Blocks (contiguously allocated VRBs) in the active uplink BWP. The VRBs in the active uplink BWP are mapped to the physical resource blocks in the same active uplink BWP.

RIV 0_0 may be given at least based on RB_{UL_start} and L_{UL_RBs}. RB_{UL_start} is a starting resource block of the set of contiguously allocated VRBs. L_{UL_RBS} is a length of the set of contiguously allocated VRBs (the number of resource blocks). Here, indexing of the resource blocks is determined in the active uplink BWP. Specifically, indexing (numbering) of the resource blocks related to RIV 0_0, RB_{UL_start}, and L_{UL_RBs} is started from the lowest resource block in the active uplink BWP. Here, the lowest resource block may be the resource block having the lowest frequency. The lowest resource block may be the resource block having the lowest index of a common resource block.

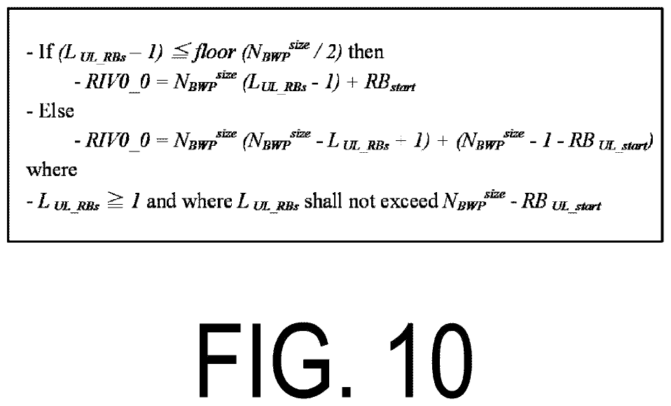

FIG. 10 is a diagram illustrating pseudocode for calculating RIV 0_0 according to the present embodiment. Except for a case that the size of DCI format 0_0 in the USS is derived from the size of the initial uplink BWP and the DCI format 0_0 is applied to the active uplink BWP being different from the initial uplink BWP, RIV 0_0 may be given by using N_{UL,BWP}^{size}, based on the pseudocode of FIG. 10.

Except for a case that the size of DCI format 0_0 in the USS is derived from the size of the initial uplink BWP and the DCI format 0_0 is applied to the active uplink BWP being different from the initial uplink BWP, the terminal apparatus 1 may acquire RB_{UL_start} and L_{UL_RBS}, based on RIV 0_0 and N_{UL_BWP}^{size}.

Except for a case that DCI format 0_0 is decoded in the CSS, N_{UL_BWP}^{size} is the size of the active uplink BWP. In a case that DCI format 0_0 is decoded in the USS, N_{UL_BWP}^{size} is the size of the active uplink BWP. In a case that DCI format 0_0 is decoded in the CSS, N_{UL_BWP}^{size} is the size of the initial uplink BWP.

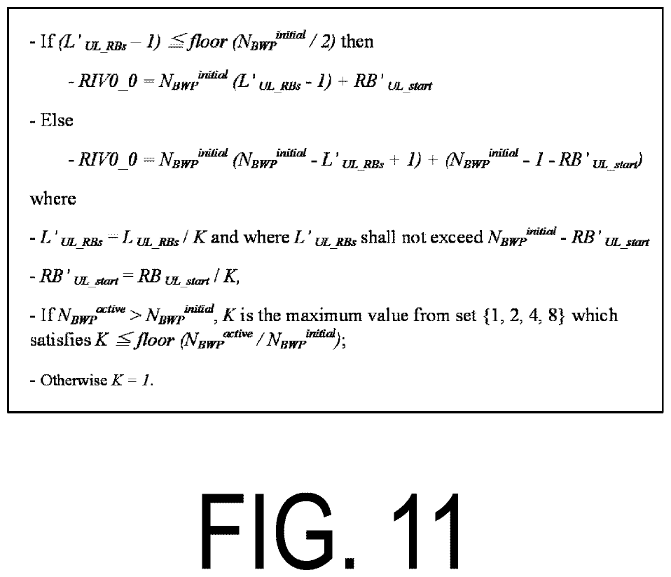

FIG. 11 is a diagram illustrating pseudocode for calculating RIV 0_0 according to the present embodiment. In a case that the size of DCI format 0_0 in the USS is derived from the size of the initial uplink BWP and the DCI format 0_0 is applied to the active uplink BWP being different from the initial uplink BWP, RIV 0_0 may be given by using N_{UL_BWP}^{initial} and N_{UL_BWP}^{active} based on the pseudocode of FIG. 11.

In a case that the size of DCI format 0 0 in the USS is derived from the size of the initial uplink BWP and the DCI format 0_0 is applied to the active uplink BWP being different from the initial uplink BWP, the terminal apparatus 1 may acquire RB_{UL_start} and L_{UL_RBS}, based on RIV 0_0, N_{UL_BWP}^{initial}, and N_{UL_BWP}^{active}.

N_{UL_BWP}^{initial} is the size of the initial uplink BWP. N_{UL_BWP}^{active} is the size of the active uplink BWP.

The ‘Frequency domain resource assignment’ field of DCI format 1_0 includes a Resource Indication Value (RIV). The RIV included in the ‘Frequency domain resource assignment’ field of DCI format 1_0 is also referred to as RIV 1_0.

Calculation of RIV 1_0 in the base station apparatus 3 is performed based on a type (the CSS or the USS) of the search space in which DCI format 1_0 is transmitted. Interpretation of RIV 1_0 in the terminal apparatus 1 is performed based on a type (the CSS or the USS) of the search space in which DCI format 1_0 is transmitted.

RIV 1_0 may indicate resource block assignment information. The resource block assignment information of RIV 1_0 indicates, for the scheduled terminal apparatus 1, a set of contiguously allocated Virtual Resource Blocks (contiguously allocated VRBs) in the active downlink BWP. The VRBs in the active downlink BWP are mapped to the physical resource blocks in the same active downlink BWP.

RIV 1_0 may be given at least based on RB_{DL_start} and L_{DL_RBs}. RB_{DL_start} is a starting resource block of the set of contiguously allocated VRBs. L_{DL_RBs} is a length of the set of contiguously allocated VRBs (the number of resource blocks). Here, regardless of which downlink BWP is the active downlink BWP for the PDSCH scheduled by using DCI format 1_0 in the CSS, indexing (numbering) of the resource blocks may start from the lowest resource block of the CORESET in which the DCI format 1_0 is received. Here, the lowest resource block may be the resource block having the lowest frequency. The lowest resource block may be the resource block having the lowest index of a common resource block. Here, indexing of the resource blocks may be determined in the active downlink BWP for the PDSCH scheduled by using the DCI format other than DCI format 1_0 in the CSS. Specifically, indexing (numbering) of the resource blocks related to RIV 1_0, RB_{DL_start}, and L_{DL_RBs} may start from the lowest resource block in the active downlink BWP. The DCI format other than DCI format 1_0 in the CSS may be DCI format 1_0 in the USS.

Alternatively, for the PDSCH scheduled by using DCI format 1_0 accompanied with an SI-RNTI, indexing (numbering) of the resource blocks may start from the lowest resource block of the CORESET in which the DCI format 1_0 is received, and for the PDSCH scheduled by using DCI format 1_0 accompanied with a C-RNTI, indexing of the resource blocks may be determined in the active downlink BWP. Here, DCI format 1_0 accompanied with the SI-RNTI and DCI format 1_0 accompanied with the C-RNTI may be transmitted and/or received in the CSS.

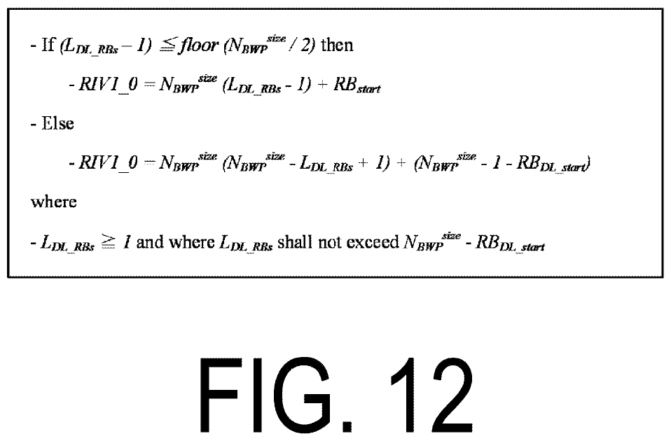

FIG. 12 is a diagram illustrating pseudocode for calculating RIV 1_0 according to the present embodiment. Except for a case that the size of DCI format 1_0 in the USS is derived from the size of the prescribed band X and the DCI format 1_0 is applied to the active downlink BWP being different from the prescribed band X, RIV 1_0 may be given N_{DL,BWP}^{size}, based on the pseudocode of FIG. 12.

Except for a case that the size of DCI format 1_0 in the USS is derived from the size of the prescribed band X and the DCI format 1_0 is applied to the active downlink BWP being different from the prescribed band X, the terminal apparatus 1 may acquire RB_{DL_start} and L_{DL_RBs}, based on RIV 1_0 and N_{DL_BWP}^{size}.

Except for a case that DCI format 1_0 is decoded in the CSS, N_{DL_BWP}^{size} is the size of the active downlink BWP. In a case that DCI format 1_0 is decoded in the USS, N_{DL_BWP}^{size} is the size of the active downlink BWP. In a case that DCI format 1_0 is decoded in the CSS, N_{DL_BWP}^{size} is the size of the prescribed band X.

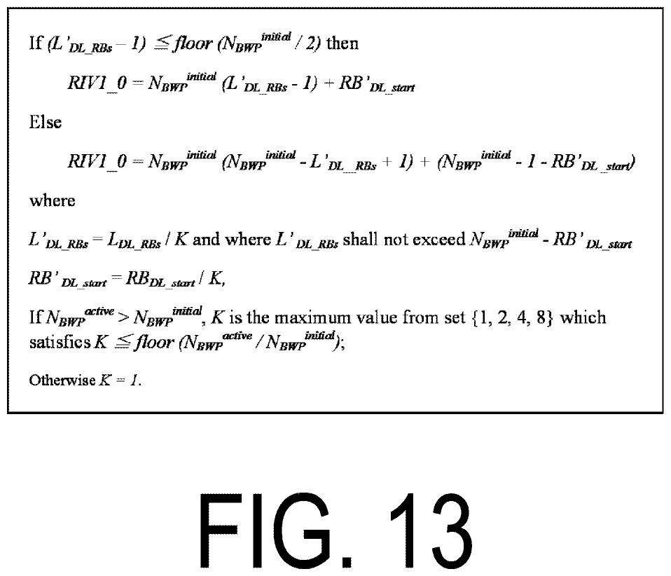

FIG. 13 is a diagram illustrating pseudocode for calculating RIV 1_0 according to the present embodiment. In a case that the size of DCI format 1_0 in the USS is derived from the size of the prescribed band X and the DCI format 1_0 is applied to the active downlink BWP being different from the prescribed band X, RIV 1_0 may be given by using N_{DL_BWP}^{initial} and N_{DL_BWP}^{active}, based on the pseudocode of FIG. 13.

In a case that the size of DCI format 1_0 in the USS is derived from the size of the prescribed band X and the DCI format 1_0 is applied to the active downlink BWP being different from the prescribed band X, the terminal apparatus 1 may acquire RB_{UL_start} and L_{UL_RBS}, based on RIV 1_0, N_{DL_BWP}^{initial}, and N_{DL_BWP}^{active}.

N_{DL_BWP}^{initial} is the size of the prescribed band X. N_{DL_BWP}^{active} is the size of the active downlink BWP.

Scrambling of the PDCCH will be described below.

A scrambling sequence c_{PDCCH}(i) used for scrambling of the PDCCH may be initialized by using c_{PDCCH_init}. c_{PDCCH_init} may be given at least based on n_{RNTI} and n_{ID}. c_{PDCCH_init} may be given based on the following equation (3).

c_{PDCCH_init}=(n_{RNTI}·2¹⁶+n_{ID})mod 2²¹ [Equation 3]

In a case that a higher layer parameter PDCCH-DMRS-Scrambling-ID is configured, n_{ID} may be given by the higher layer parameter PDCCH-DMRS-Scrambling-ID for the PDCCH in the USS. Otherwise (in a case that the higher layer parameter PDCCH-DMRS-Scrambling-ID is not configured, or for the CSS), n_{ID} may be given by a physical layer cell identity.

The higher layer parameter PDCCH-DMRS-Scrambling-ID may be configured for the CORESET. The higher layer parameter PDCCH-DMRS-Scrambling-ID may be configured for the serving cell. The higher layer parameter PDCCH-DMRS-Scrambling-ID may be configured for the terminal apparatus 1.

In the case that the higher layer parameter PDCCH-DMRS-Scrambling-ID is configured, n_{RNTI} is the C-RNTI for the PDCCH in the USS. Otherwise (in a case that the higher layer parameter PDCCH-DMRS-Scrambling-ID is not configured, or for the CSS), n_{RNTI} is 0. In the present embodiment, the C-RNTI is a value different from 0. Thus, in the present embodiment, in the case that the higher layer parameter PDCCH-DMRS-Scrambling-ID is configured, the scrambling sequence c_{PDCCH}(i) for the PDCCH in the USS is different from the scrambling sequence c_{PDCCH}(i) for the PDCCH in the CSS. In the present embodiment, in the case that the higher layer parameter PDCCH-DMRS-Scrambling-ID is not configured, the scrambling sequence c_{PDCCH}(i) for the PDCCH in the USS is the same as the scrambling sequence c_{PDCCH}(i) for the PDCCH in the CSS.

A reference signal sequence of the DMRS for the PDCCH will be described below.

The reference signal sequence of the DMRS for the PDCCH is given by a pseudo-random sequence c_{DMRS}(i). The pseudo-random sequence c_{DMRS}(i) may be initialized by using c_{DMRS_init}. c_{DMRS_init} may be given at least based on N_{ID} or the above-described n_{ID}.

In the case that the higher layer parameter PDCCH-DMRS-Scrambling-ID is configured, N_{ID} may be given by the higher layer parameter PDCCH-DMRS-Scrambling-ID. Otherwise (in a case that the higher layer parameter PDCCH-DMRS-Scrambling-ID is not configured), N_{ID} may be given by a physical layer cell identity. Specifically, in the present embodiment, in the case that the higher layer parameter PDCCH-DMRS-Scrambling-ID is not configured, regardless of whether c_{DMRS_init} is given based on either N_{ID} or n_{ID}, the scrambling sequence c_{PDCCH}(i) for the PDCCH in the USS is the same as the scrambling sequence c_{PDCCH}(i) for the PDCCH in the CSS.

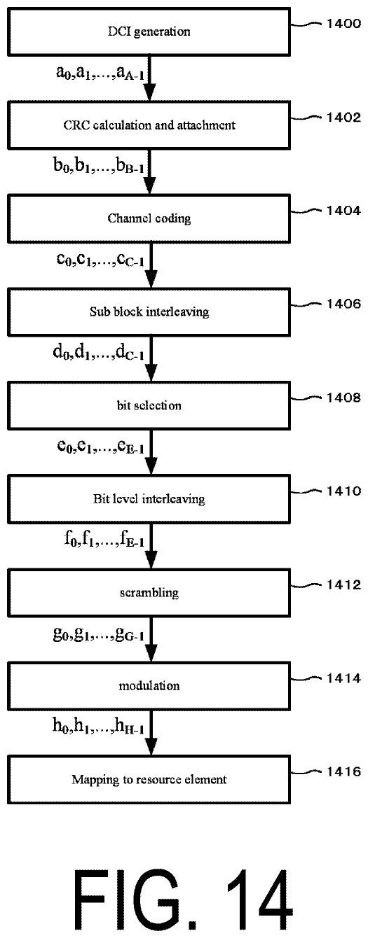

FIG. 14 is a diagram illustrating an example of processing related to the downlink control information according to the present embodiment. The base station apparatus 3 may execute a part or all of processing of 1400 to 1416, based on the aggregation level of the PDCCH used for transmission of downlink control information

In 1400, the base station apparatus 3 generates the downlink control information aᵢ. A represents the number of bits of the downlink control information.

In 1402, the base station apparatus 3 generates a bit sequence bᵢ by generating CRC parity bits based on the downlink control information aᵢ and adding the CRC parity bits to the downlink control information aᵢ. B represents the sum of the number of CRC parity bits and A. The base station apparatus 3 may scramble the CRC parity bits with an RNTI.

In 1404, the base station apparatus 3 generates a coded bit cᵢ by performing channel coding on the bit sequence bᵢ. The channel code may be a polar code or a convolutional code. C represents the number of channel coded bits. In the base station apparatus 3, the coded bit cᵢ may be given by a product of a matrix u′ and a matrix G′.

The matrix G′ is a matrix having C rows and C columns, and may be given by n-th Kronecker power of a matrix G₀ having two rows and two columns.

matrix u′=[u₀, u₁, . . . , u_{C-1}] is a matrix having one row and C columns, and is generated based on the bit sequence bᵢ. The matrix u′ may be generated based further on information x indicating the aggregation level.

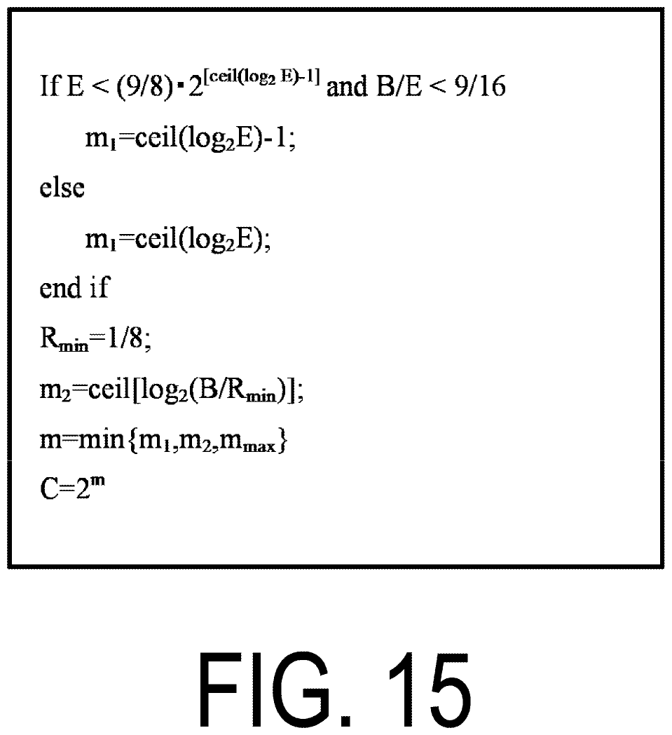

FIG. 15 is a diagram illustrating an example of pseudocode for calculating C according to the present embodiment. E represents the number of bits of a sequence eᵢ.

E may be given based on the aggregation level. E may be given by a product of the aggregation level and 108. ceil(·) is a function that returns the smallest integer that is larger than an input value. ceil(·) is a function that returns the smallest integer out of input values. Specifically, C may be given based on the aggregation level. C for the aggregation level of 8 is the same as C for the aggregation level of 16.

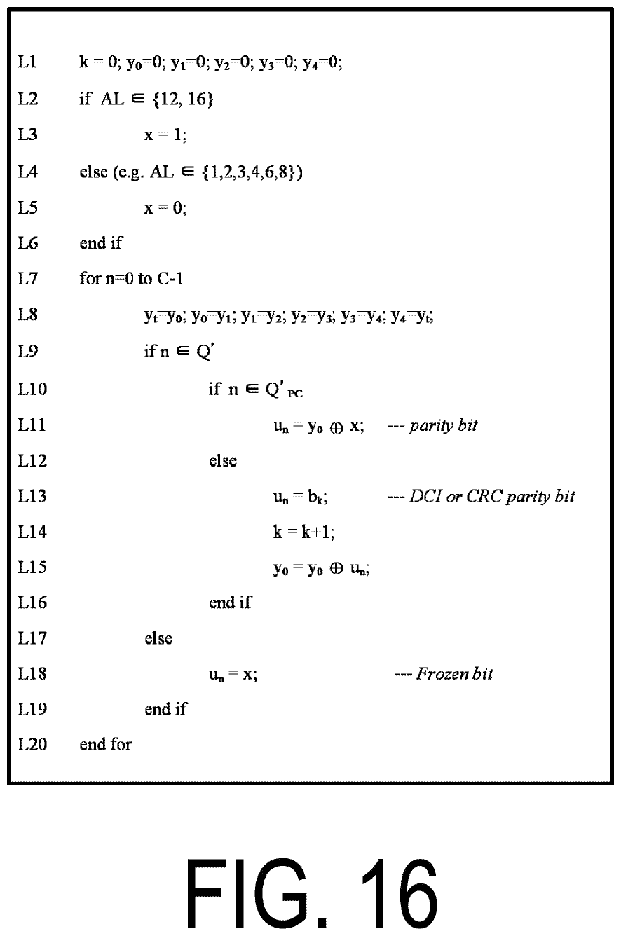

FIG. 16 is a diagram illustrating an example of pseudocode for generating the matrix u′ according to the present embodiment. In L2 to L6, the information x indicating the aggregation level is set to 1 or 0, based on the aggregation level of the PDCCH used for transmission of the downlink control information aᵢ. The information x indicating the aggregation level is a variable x that is set based on the aggregation level.

In L11, parity bits that are generated based on the information x indicating the aggregation level are set to an element uₙ of the matrix u′. Q′_{PC} represents a set of indexes n of the element uₙ to which the parity bits are set.

In L13, an element bₖ of the sequence bᵢ is set to the element uₙ of the matrix u′. Q′ represents a set of indexes n of the element uₙ to which the parity bits or the element bₖ of the sequence bᵢ is set. Q′_{PC} is a subset of Q′.

In L18, the variable x set based on the aggregation level is set to the element uₙ of the matrix u′. The element uₙ to which the variable x set based on the aggregation level is set is the element uₙ corresponding to the index n other than Q′. The element uₙ to which the variable x set based on the aggregation level is set is also referred to as a frozen bit.

In 1406, the base station apparatus 3 may generate a sequence dᵢ by interleaving the sequence cᵢ.

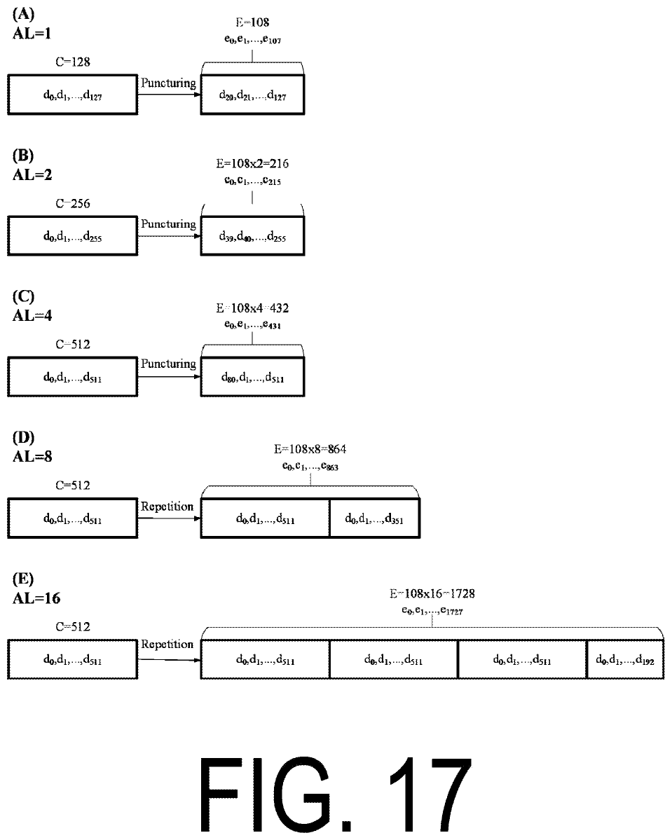

In 1408, the base station apparatus 3 may generate a sequence eᵢ by repeating or puncturing the sequence dᵢ. FIG. 17 is a diagram illustrating an example of bit selection of the sequence dᵢ according to the present embodiment. In (A), (B), and (C) of FIG. 17, the sequence eᵢ is generated by puncturing the sequence dᵢ. Specifically, in a case that the aggregation level is 1, 2, or 4, the sequence eᵢ is generated by puncturing the sequence dᵢ. In (D) and (E) of FIG. 17, sequence eᵢ is generated by repeating the sequence dᵢ. Specifically, in a case that the aggregation level is 8 or 16, the sequence eᵢ is generated by repeating the sequence dᵢ. C for the aggregation level of 8 is the same as C for the aggregation level of 16, and thus e₀, . . . , e₈₆₃ corresponding to the aggregation level of 8 is the same as e₀, . . . , e₈₆₃ corresponding to the aggregation level of 16.

In 1410, the base station apparatus 3 may generate a sequence fᵢ by interleaving the sequence eᵢ.

In 1412, the base station apparatus 3 may generate a sequence gᵢ by scrambling the sequence fᵢ by using the scrambling sequence, based on the scrambling sequence c_{PDCCH}(i) described above.

In 1414, the base station apparatus 3 generates a sequence hᵢ of a modulation symbol (complex value symbol), based on the sequence gᵢ. In 1416, the base station apparatus 3 maps the modulation symbol hᵢ to the resource element corresponding to the PDCCH candidate.

The terminal apparatus 1 assumes the processing of 1400 to 1414, and monitors the PDCCH.

As described above, the terminal apparatus 1 switches processing depending on whether the PDCCH is received in the CSS or the USS. In a case that a condition C is satisfied, however, the terminal apparatus 1 cannot correctly determine whether the PDCCH is transmitted in the PDCCH candidate of the CSS or the PDCCH candidate of the USS, and this presents a problem.

The condition C includes at least a part or all of the following conditions C1, C2, C3, C4, C5, C6, and C7.

The condition C1 may be a condition that the terminal apparatus 1 is configured to monitor the PDCCH candidate in the CSS and the PDCCH candidate in the USS according to DCI format 0_0/1_0 accompanied with the C-RNTI in one PDCCH monitoring occasion in one CORESET. The condition C1 may be a condition that the terminal apparatus 1 is configured to monitor the PDCCH candidate in the CSS and the PDCCH candidate in the USS according to DCI format 0_0/1_0 accompanied with the C-RNTI in one CORESET.

The condition C2 may be a condition that a period of the CORESET is one OFDM symbol.

The condition C3 may be a condition that the CORESET is the non-interleaved CORESET.

The condition C4 may be a condition that one of the PDCCH candidate in the CSS and the PDCCH candidate in the USS is of the aggregation level of 8, while the other of the PDCCH candidate in the CSS and the PDCCH candidate in the USS is of the aggregation level of 16.

The condition C5 may be a condition that the lowest index of the CCE constituting the PDCCH candidate in the CSS is the same as the lowest index of the CCE constituting the PDCCH candidate in the USS. For example, in FIG. 7, the lowest index of the CCE constituting the PDCCH candidate 702 of the CSS 700 is the same as the lowest index of the CCE constituting the PDCCH candidate 711 of the USS 710. The condition C5 may be a condition that the CCE having the lowest index constituting the PDCCH candidate in the CSS is the same as the CCE having the lowest index constituting the PDCCH candidate in the USS.

The condition C6 may be a condition that the higher layer parameter PDCCH-DMRS-Scrambling-ID is not configured for the terminal apparatus 1. The condition C6 may be a condition that the higher layer parameter PDCCH-DMRS-Scrambling-ID is not configured for the CORESET. The condition C6 may be a condition that a DMRS corresponding to the PDCCH candidate of the CSS is the same as a DMRS corresponding to the PDCCH candidate of the USS, and a PDCCH scrambling sequence corresponding to the PDCCH candidate of the CSS is the same as a PDCCH scrambling sequence corresponding to the PDCCH candidate of the USS. The condition C6 may be a condition that the PDCCH scrambling sequence corresponding to the PDCCH candidate of the CSS is the same as the PDCCH scrambling sequence corresponding to the PDCCH candidate of the USS.

The condition C7 may be a condition that the size of DCI format 0_0/1_0 corresponding to the PDCCH candidate in the CSS is the same as the size of DCI format 0_0/1_0 corresponding to the PDCCH candidate in the USS. In the condition C4, the set of fields of DCI format 0_0 corresponding to the PDCCH candidate in the CSS may be the same as or different from the set of fields of DCI format 0_0 corresponding to the PDCCH candidate in the USS. In the condition C7, the set of fields of DCI format 1_0 corresponding to the PDCCH candidate in the CSS may be the same as or different from the set of fields of DCI format 1_0 corresponding to the PDCCH candidate in the USS.

DCI format 0_0/1_0 may signify (1) DCI format 0_0, (2) DCI format 1_0, or (3) DCI format 0_0 and DCI format 1_0.

In view of this, in a case that the condition C is satisfied, the terminal apparatus 1 may perform any of the following processings D1 to D8 on the PDCCH candidate of the CSS and the PDCCH candidate of the USS of the condition C. Specifically, the terminal apparatus 1 may determine whether or not any of the following processings D1 to D8 is performed, based on whether or not the condition C is satisfied.
(Processing D1) It is considered that the PDCCH accompanied with DCI format 0_0/1_0 is transmitted only in the PDCCH candidate of the CSS out of the PDCCH candidate of the CSS and the PDCCH candidate of the USS. Here, the terminal apparatus 1 may not monitor the PDCCH accompanied with DCI format 0_0/1_0 in the PDCCH candidate of the USS.
(Processing D2) It is considered that the PDCCH accompanied with DCI format 0_0/1_0 is transmitted only in the PDCCH candidate of the USS out of the PDCCH candidate of the CSS and the PDCCH candidate of the USS. Here, the terminal apparatus 1 may not monitor the PDCCH accompanied with DCI format 0_0/1_0 in the PDCCH candidate of the CSS.
(Processing D3) It is considered that the PDCCH accompanied with DCI format 0_0/1_0 is transmitted or received in the PDCCH candidate of the USS instead of the PDCCH candidate of the CSS in a case that the PDCCH accompanied with DCI format 0_0/1_0 is detected in the PDCCH candidate of the CSS.
(Processing D4) It is considered that the PDCCH accompanied with DCI format 0_0/1_0 is transmitted or received in the PDCCH candidate of the CSS instead of the PDCCH candidate of the USS in a case that the PDCCH accompanied with DCI format 0_0/1_0 is detected in the PDCCH candidate of the USS.
(Processing D5) It is considered that the PDCCH accompanied with DCI format 0_0/1_0 is transmitted only in the PDCCH candidate having the aggregation level of 8 out of the PDCCH candidate of the CSS and the PDCCH candidate of the USS. Here, the terminal apparatus 1 may not monitor the PDCCH accompanied with DCI format 0_0/1_0 in the PDCCH candidate having the aggregation level of 16.
(Processing D6) It is considered that the PDCCH accompanied with DCI format 0_0/1_0 is transmitted only in the PDCCH candidate having the aggregation level of 16 out of the PDCCH candidate of the CSS and the PDCCH candidate of the USS. Here, the terminal apparatus 1 may not monitor the PDCCH accompanied with DCI format 0_0/1_0 in the PDCCH candidate having the aggregation level of 8.
(Processing D7) It is considered that the PDCCH accompanied with DCI format 0_0/1_0 is transmitted or received in the PDCCH candidate having the aggregation level of 16 instead of the PDCCH candidate having the aggregation level of 8 in a case that the PDCCH accompanied with DCI format 0_0/1_0 is detected in the PDCCH candidate having the aggregation level of 8.
(Processing D8) It is considered that the PDCCH accompanied with DCI format 0_0/1_0 is transmitted or received in the PDCCH candidate having the aggregation level of 8 instead of the PDCCH candidate having the aggregation level of 16 in a case that the PDCCH accompanied with DCI format 0_0/1_0 is detected in the PDCCH candidate having the aggregation level of 16.

In a case that the condition C is not satisfied, the terminal apparatus 1 considers that the PDCCH accompanied with DCI format 0_0/1_0 may be transmitted in one of the PDCCH candidates out of the PDCCH candidate of the CSS and the PDCCH candidate of the USS. In the case that the condition C is not satisfied, the terminal apparatus 1 may monitor both of the PDCCH candidate of the CSS and the PDCCH candidate of the USS.

In view of this, in a case that the condition C is satisfied, the base station apparatus 3 may perform any of the following processings E1 to E8 on the PDCCH candidate of the CSS and the PDCCH candidate of the USS of the condition C. Specifically, the base station apparatus 3 may determine whether or not any of the following processings E1 to E8 is performed, based on whether or not the condition C is satisfied.
(Processing E1) The PDCCH accompanied with DCI format 0_0/1_0 is transmitted only in the PDCCH candidate of the CSS out of the PDCCH candidate of the CSS and the PDCCH candidate of the USS.
(Processing E2) The PDCCH accompanied with DCI format 0_0/1_0 is transmitted only in the PDCCH candidate of the USS out of the PDCCH candidate of the CSS and the PDCCH candidate of the USS.
(Processing E3) It is considered that the PDCCH accompanied with DCI format 0_0/1_0 is transmitted in the PDCCH candidate of the USS instead of the PDCCH candidate of the CSS, in a case that the PDCCH accompanied with DCI format 0_0/1_0 is transmitted in the PDCCH candidate of the CSS.
(Processing E4) It is considered that the PDCCH accompanied with DCI format 0_0/1_0 is transmitted in the PDCCH candidate of the CSS instead of the PDCCH candidate of the USS, in a case that the PDCCH accompanied with DCI format 0_0/1_0 is transmitted in the PDCCH candidate of the USS.
(Processing E5) The PDCCH accompanied with DCI format 0_0/1_0 is transmitted only in the PDCCH candidate having the aggregation level of 8 out of the PDCCH candidate of the CSS and the PDCCH candidate of the USS.
(Processing E6) The PDCCH accompanied with DCI format 0_0/1_0 is transmitted only in the PDCCH candidate having the aggregation level of 16 out of the PDCCH candidate of the CSS and the PDCCH candidate of the USS.
(Processing E7) It is considered that the PDCCH accompanied with DCI format 0_0/1_0 is transmitted in the PDCCH candidate having the aggregation level of 16 instead of the PDCCH candidate having the aggregation level of 8, in a case that the PDCCH accompanied with DCI format 0_0/1_0 is transmitted in the PDCCH candidate having the aggregation level of 8.
(Processing E8) It is considered that the PDCCH accompanied with DCI format 0_0/1_0 is transmitted in the PDCCH candidate having the aggregation level of 8 instead of the PDCCH candidate having the aggregation level of 16, in a case that the PDCCH accompanied with DCI format 0_0/1_0 is transmitted in the PDCCH candidate having the aggregation level of 16.

In a case that the condition C is not satisfied, the base station apparatus 3 may transmit the PDCCH accompanied with DCI format 0_0/1_0 in any of the PDCCH candidate of the CSS and the PDCCH candidate of the USS.

In this manner, in a case that the condition C is satisfied, the terminal apparatus 1 can correctly determine whether the PDCCH is transmitted in the PDCCH candidate of the CSS or the PDCCH candidate of the USS of the condition C.

The System Information-Radio Network Temporary Identifier (SI-RNTI) is used to broadcast System Information (SI). Specifically, the SI-RNTI is used to schedule a System Information Block (SIB). The terminal apparatus 1 may monitor DCI format 1_0 accompanied with the SI-RNTI used for scheduling an SIB 1 in a type 0 CSS. The terminal apparatus 1 may monitor DCI format 1_0 accompanied with the SI-RNTI used for scheduling an SIB other than the SIB 1 in a type 0a CSS.

A Random Access-Radio Network Temporary Identifier (RA-RNTI) is used for a random access response. The terminal apparatus 1 may monitor DCI format 1_0 accompanied with the RA-RNTI in a type 1 CSS.

The CSS of the first type may at least include the type 0 CSS, the type 0a CSS, and/or the type 1 CSS. The CSS of the second type may at least include the type 0 CSS, the type 0a CSS, and/or the type 1 CSS. Each of the type 0 CSS, the type 0a CSS, and the type 1 CSS belongs to any of the CSS of the first type and the CSS of the second type. For example, the CSS of the first type may include the type 0 CSS, and the CSS of the second type may include the type 0a CSS and the type 1 CSS.

For DCI format 1_0 corresponding to the PDCCH candidate of the CSS of the first type, the prescribed band X may be the above-described prescribed CORESET. Specifically, the number of bits of the ‘Frequency domain resource assignment’ field of DCI format 1_0 corresponding to the PDCCH candidate of the CSS of the first type may be derived from the above-described prescribed CORESET. Here, for the sake of calculation of the RIV set to the ‘Frequency domain resource assignment’ field of DCI format 1_0 corresponding to the PDCCH candidate of the CSS of the first type, N_{DL_BWP}^{size} may be set to the above-described prescribed CORESET. Specifically, the RIV set to the ‘Frequency domain resource assignment’ field of DCI format 1_0 corresponding to the PDCCH candidate of the CSS of the first type may be derived from the above-described prescribed CORESET.

For DCI format 1_0 corresponding to the PDCCH candidate of the CSS of the second type, the prescribed band X may be the initial downlink BWP. Specifically, the number of bits of the ‘Frequency domain resource assignment’ field of DCI format 1_0 corresponding to the PDCCH candidate of the CSS of the second type may be derived from the initial downlink BWP. Here, for the sake of calculation of the RIV set to the ‘Frequency domain resource assignment’ field of DCI format 1_0 corresponding to the PDCCH candidate of the CSS of the second type, N_{DL,BWP}^{size} may be set to the initial downlink BWP. Specifically, the RIV set to the ‘Frequency domain resource assignment’ field of DCI format 1_0 corresponding to the PDCCH candidate of the CSS of the second type may be derived from the initial downlink BWP.

As described above, the terminal apparatus 1 switches processing depending on in which type of the CSS the PDCCH is received. In a case that a condition F is satisfied, however, the terminal apparatus 1 cannot correctly determine the type of the PDCCH candidate in which the PDCCH is transmitted, and this presents a problem.

The condition F at least includes a part or all of the following conditions F1, F2, F3, F4, F5, and F6.

The condition F1 may be a condition that the terminal apparatus 1 is configured to monitor the PDCCH candidate in the CSS of the first type and the PDCCH candidate in the CSS of the second type according to DCI format 1_0 accompanied with the C-RNTI in one PDCCH monitoring occasion in one CORESET. The condition F1 may be a condition that the terminal apparatus 1 is configured to monitor the PDCCH candidate in the CSS of the first type and the PDCCH candidate of the second type according DCI format 1_0 accompanied with the C-RNTI in one CORESET. The C-RNTI of the condition F1 may be an RNTI (for example, the SI-RNTI or the RA-RNTI) that is other than the C-RNTI.

The condition F2 may be a condition that the period of the CORESET is one OFDM symbol.

The condition F3 may be a condition that the CORESET is the non-interleaved CORESET.

The condition F4 may be a condition that one of the PDCCH candidate in the CSS of the first type and the PDCCH candidate in the CSS of the second type is of the aggregation level of 8, while the other of the PDCCH candidate in the CSS of the first type and the PDCCH candidate in the CSS of the second type is of the aggregation level of 16.

The condition F5 may be a condition that the lowest index of the CCE constituting the PDCCH candidate in the CSS of the first type is the same as the lowest index of the CCE constituting the PDCCH candidate of the second type. The condition F5 may be a condition that the CCE having the lowest index constituting the PDCCH candidate in the CSS of the first type is the same as the CCE having the lowest index constituting the PDCCH candidate in the CSS of the second type.

The condition F6 may be a condition that the size of DCI format 1_0 corresponding to the PDCCH candidate in the CSS of the first type is the same as the size of DCI format 1_0 corresponding to the PDCCH candidate of the second type. In the condition F6, the set of fields of DCI format 1_0 corresponding to the PDCCH candidate in the CSS of the first type may be the same as or different from the set of fields of DCI format 1_0 corresponding to the PDCCH candidate in the CSS of the second type.

In the condition F, whether or not the higher layer parameter PDCCH-DMRS-Scrambling-ID is configured does not make any difference. Specifically, in the condition F, whether or not the higher layer parameter PDCCH-DMRS-Scrambling-ID is configured for the CORESET does not make any difference. Specifically, the terminal apparatus 1 need not determine whether or not the higher layer parameter PDCCH-DMRS-Scrambling-ID is configured in a case of determining whether or not the condition F is satisfied.

In view of this, in a case that the condition F is satisfied, the terminal apparatus 1 may perform any of the following processings G1 to G8 on the PDCCH candidate of the CSS of the first type and the PDCCH candidate of the CSS of the second type of the condition F. Specifically, the terminal apparatus 1 may determine whether or not any of the following processings G1 to G8 is performed, based on whether or not the condition F is satisfied.
(Processing G1) It is considered that the PDCCH accompanied with DCI format 1_0 is transmitted only in the PDCCH candidate of the CSS of the first type out of the PDCCH candidate of the CSS of the first type and the PDCCH candidate of the second type. Here, the terminal apparatus 1 may not monitor the PDCCH accompanied with DCI format 1_0 in the PDCCH candidate of the second CSS.
(Processing G2) It is considered that the PDCCH accompanied with DCI format 1_0 is transmitted only in the PDCCH candidate of the second type out of the PDCCH candidate of the CSS of the first type and the PDCCH candidate of the CSS of the second type. Here, the terminal apparatus 1 may not monitor the PDCCH accompanied with DCI format 1_0 in the PDCCH candidate of the CSS of the first type.
(Processing G3) It is considered that the PDCCH accompanied with DCI format 1_0 is transmitted or received in the PDCCH candidate of the second type instead of the PDCCH candidate of the CSS of the first type in a case that the PDCCH accompanied with DCI format 1_0 is detected in the PDCCH candidate of the CSS of the first type.
(Processing G4) It is considered that the PDCCH accompanied with DCI format 1_0 is transmitted or received in the PDCCH candidate of the CSS of the first type instead of the PDCCH candidate of the CSS of the second type in a case that the PDCCH accompanied with DCI format 1_0 is detected in the PDCCH candidate of the CSS of the second type.
(Processing G5) It is considered that the PDCCH accompanied with DCI format 1_0 is transmitted only in the PDCCH candidate having the aggregation level of 8 out of the PDCCH candidate of the CSS of the first type and the PDCCH candidate of the second type. Here, the terminal apparatus 1 may not monitor the PDCCH accompanied with DCI format 1_0 in the PDCCH candidate having the aggregation level of 16.
(Processing G6) It is considered that the PDCCH accompanied with DCI format 1_0 is transmitted only in the PDCCH candidate having the aggregation level of 16 out of the PDCCH candidate of the CSS of the first type and the PDCCH candidate of the second type. Here, the terminal apparatus 1 may not monitor the PDCCH accompanied with DCI format 1_0 in the PDCCH candidate having the aggregation level of 8.
(Processing G7) It is considered that the PDCCH accompanied with DCI format 1_0 is transmitted or received in the PDCCH candidate having the aggregation level of 16 instead of the PDCCH candidate having the aggregation level of 8 in a case that the PDCCH accompanied with DCI format 1_0 is detected in the PDCCH candidate having the aggregation level of 8.
(Processing G8) It is considered that the PDCCH accompanied with DCI format 1_0 is transmitted or received in the PDCCH candidate having the aggregation level of 8 instead of the PDCCH candidate having the aggregation level of 16 in a case that the PDCCH accompanied with DCI format 1_0 is detected in the PDCCH candidate having the aggregation level of 16.

In a case that the condition F is not satisfied, the terminal apparatus 1 considers that the PDCCH accompanied with DCI format 1_0 may also be transmitted in any of the PDCCH candidates out of the PDCCH candidate of the CSS of the first type and the PDCCH candidate of the CSS of the second type. In the case that the condition F is not satisfied, the terminal apparatus 1 may monitor both of the PDCCH candidate of the CSS of the first type and the PDCCH candidate of the CSS of the second type.

In view of this, in a case that the condition F is satisfied, the base station apparatus 3 may perform any of the following processings H1 to H8 on the PDCCH candidate of the CSS of the first type and the PDCCH candidate of the CSS of the second type of the condition F. Specifically, the base station apparatus 3 may determine whether or not any of the following processings H1 to H8 is performed, based on whether or not the condition F is satisfied.
(Processing H1) The PDCCH accompanied with DCI format 1_0 is transmitted only in the PDCCH candidate of the CSS of the first type out of the PDCCH candidate of the CSS of the first type and the PDCCH candidate of the second type.
(Processing H2) The PDCCH accompanied with DCI format 1_0 is transmitted only in the PDCCH candidate of the second type out of the PDCCH candidate of the CSS of the first type and the PDCCH candidate of the CSS of the second type.
(Processing H3) It is considered that the PDCCH accompanied with DCI format 1_0 is transmitted in the PDCCH candidate of the second type instead of the PDCCH candidate of the CSS of the first type in a case that the PDCCH accompanied with DCI format 1_0 is transmitted in the PDCCH candidate of the CSS of the first type.
(Processing H4) It is considered that the PDCCH accompanied with DCI format 1_0 is transmitted in the PDCCH candidate of the CSS of the first type instead of the PDCCH candidate of the CSS of the second type in a case that the PDCCH accompanied with DCI format 1_0 is transmitted in the PDCCH candidate of the CSS of the second type.
(Processing H5) The PDCCH accompanied with DCI format 1_0 is transmitted only in the PDCCH candidate having the aggregation level of 8 out of the PDCCH candidate of the CSS of the first type and the PDCCH candidate of the second type.
(Processing H6) The PDCCH accompanied with DCI format 1_0 is transmitted only in the PDCCH candidate having the aggregation level of 16 out of the PDCCH candidate of the CSS of the first type and the PDCCH candidate of the second type.
(Processing H7) It is considered that the PDCCH accompanied with DCI format 1_0 is transmitted in the PDCCH candidate having the aggregation level of 16 instead of the PDCCH candidate having the aggregation level of 8 in a case that the PDCCH accompanied with DCI format 1_0 is transmitted in the PDCCH candidate having the aggregation level of 8.
(Processing H8) It is considered that the PDCCH accompanied with DCI format 1_0 is transmitted in the PDCCH candidate having the aggregation level of 8 instead of the PDCCH candidate having the aggregation level of 16 in a case that the PDCCH accompanied with DCI format 1_0 is transmitted in the PDCCH candidate having the aggregation level of 16.

In a case that the condition F is not satisfied, the base station apparatus 3 may transmit the PDCCH accompanied with DCI format 1_0 in any of the PDCCH candidate of the CSS of the first type and the PDCCH candidate of the CSS of the second type.

In this manner, in a case that the condition F is satisfied, the terminal apparatus 1 can correctly determine whether the PDCCH is transmitted in the PDCCH candidate of the CSS of the first type or the PDCCH candidate of the CSS of the second type of the condition F.

The CSS of the condition C may be the CSS of the first type and/or the CSS of the second type. In a case that both of the condition C and the condition F are satisfied, the terminal apparatus 1 may perform any of the processing G1 to the processing G4 after performing the processing D1 or the processing D3.

Hereinafter, various aspects of the terminal apparatus 1 and the base station apparatus 3 according to the present embodiment will be described.

(1) The first aspect of the present embodiment is a terminal apparatus 1. The terminal apparatus 1 includes: at least one processor; and a memory coupled to the at least one processor. The processor receives a physical downlink control channel (PDCCH) accompanied with a downlink control information (DCI) format, and receives a physical downlink shared channel (PDSCH) corresponding to a resource indication value (RIV) set to a “Frequency domain resource assignment” field of the DCI format. The RIV is given based on at least a type of a search space in which the PDCCH is detected. (1) In a case that the terminal apparatus is configured to monitor a first PDCCH candidate in a common search space (CSS) and a second PDCCH candidate in a UE-specific search space (USS) according to the DCI format accompanied with a cell radio network temporary identifier (C-RNTI) in one control resource set (CORESET), (2) in a case that a period of the CORESET is one orthogonal frequency division multiplexing (OFDM) symbol, (3) in a case that the CORESET is a non-interleaved CORESET, (4) in a case that one of the first PDCCH candidate and the second PDCCH candidate is of an aggregation level of 8 while another is of an aggregation level of 16, (5) in a case that a lowest index of a control channel element (CCE) constituting the first PDCCH candidate is identical to a lowest index of a CCE constituting the second PDCCH candidate, (6) in a case that a higher layer parameter PDCCH-DMRS-Scrambling-ID is not configured for the CORESET, and/or (7) in a case that a size of the DCI format corresponding to the first PDCCH candidate is identical to a size of the DCI format corresponding to the second PDCCH candidate, the processor considers that the PDCCH accompanied with the DCI format is transmitted only in the first PDCCH candidate out of the first PDCCH candidate and the second PDCCH candidate, or considers that the PDCCH accompanied with the DCI format is transmitted only in the second PDCCH candidate out of the first PDCCH candidate and the second PDCCH candidate, or considers that the PDCCH accompanied with the DCI format is transmitted or received in the second PDCCH candidate in a case that the PDCCH accompanied with the DCI format is received in the first PDCCH candidate, or considers that the PDCCH accompanied with the DCI format is transmitted or received in the first PDCCH candidate in a case that the PDCCH accompanied with the DCI format is received in the second PDCCH candidate, or considers that the PDCCH accompanied with the DCI format is transmitted only in the PDCCH candidate having the aggregation level of 8 out of the first PDCCH candidate and the second PDCCH candidate, or considers that the PDCCH accompanied with the DCI format is transmitted only in the PDCCH candidate having the aggregation level of 16 out of the first PDCCH candidate and the second PDCCH candidate, or considers that the PDCCH accompanied with the DCI format is transmitted or received in the PDCCH candidate having the aggregation level of 16 in a case that the PDCCH accompanied with the DCI format is detected in the PDCCH candidate having the aggregation level of 8, or considers that the PDCCH accompanied with the DCI format is transmitted or received in the PDCCH candidate having the aggregation level of 8 in a case that the PDCCH accompanied with the DCI format is detected in the PDCCH candidate having the aggregation level of 16.

(2) The second aspect of the present embodiment is a base station apparatus 3. The base station apparatus 3 includes: at least one processor; and a memory coupled to the at least one processor. The processor transmits a physical downlink control channel (PDCCH) accompanied with a downlink control information (DCI) format, and transmits a physical downlink shared channel (PDSCH) corresponding to a resource indication value (RIV) set to a “Frequency domain resource assignment” field of the DCI format. The RIV is given based on at least a type of a search space in which the PDCCH is detected. (1) In a case that the terminal apparatus is configured to monitor a first PDCCH candidate in a common search space (CSS) and a second PDCCH candidate in a UE-specific search space (USS) according to the DCI format accompanied with a cell radio network temporary identifier (C-RNTI) in one control resource set (CORESET), (2) in a case that a period of the CORESET is one orthogonal frequency division multiplexing (OFDM) symbol, (3) in a case that the CORESET is a non-interleaved CORESET, (4) in a case that one of the first PDCCH candidate and the second PDCCH candidate is of an aggregation level of 8 while another is of an aggregation level of 16, (5) in a case that a lowest index of a control channel element (CCE) constituting the first PDCCH candidate is identical to a lowest index of a CCE constituting the second PDCCH candidate, (6) in a case that a higher layer parameter PDCCH-DMRS-Scrambling-ID is not configured for the CORESET, and/or (7) in a case that a size of the DCI format corresponding to the first PDCCH candidate is identical to a size of the DCI format corresponding to the second PDCCH candidate, the processor transmits the PDCCH accompanied with the DCI format only in the first PDCCH candidate out of the first PDCCH candidate and the second PDCCH candidate, or transmits the PDCCH accompanied with the DCI format only in the second PDCCH candidate out of the first PDCCH candidate and the second PDCCH candidate, or considers that the PDCCH accompanied with the DCI format is transmitted in the second PDCCH candidate in a case that the PDCCH accompanied with the DCI format is transmitted in the first PDCCH candidate, or considers that the PDCCH accompanied with the DCI format is transmitted in the first PDCCH candidate in a case that the PDCCH accompanied with the DCI format is transmitted in the second PDCCH candidate, or transmits the PDCCH accompanied with the DCI format only in the PDCCH candidate having the aggregation level of 8 out of the first PDCCH candidate and the second PDCCH candidate, or transmits the PDCCH accompanied with the DCI format only in the PDCCH candidate having the aggregation level of 16 out of the first PDCCH candidate and the second PDCCH candidate, or considers that the PDCCH accompanied with the DCI format is transmitted in the PDCCH candidate having the aggregation level of 16 in a case that the PDCCH accompanied with the DCI format is transmitted in the PDCCH candidate having the aggregation level of 8, or considers that the PDCCH accompanied with the DCI format is transmitted in the PDCCH candidate having the aggregation level of 8 in a case that the PDCCH accompanied with the DCI format is transmitted in the PDCCH candidate having the aggregation level of 16.

(3) In the first and second aspects of the present embodiment, a set of fields of the DCI format corresponding to the first PDCCH candidate is identical to a set of fields of the DCI format corresponding to the second PDCCH candidate.

(4) In the first and second aspects of the present embodiment, the DCI format is DCI format 0_0 and/or DCI format 1_0.

(5) In the first and second aspects of the present embodiment, a scrambling sequence c_{PDCCH}(i) used for scrambling of the PDCCH is initialized using c_{PDCCH_init}. The c_{PDCCH_init} is given based on at least n_{RNTI}. The n_{RNTI} is the C-RNTI for the PDCCH in the USS in a case that the higher layer parameter PDCCH-DMRS-Scrambling-ID is configured for the CORESET, otherwise the n_{RNTI} is 0. The C-RNTI is a value different from 0.

With this configuration, the terminal apparatus 1 and the base station apparatus 3 can efficiently perform communication.

Each of a program running on the base station apparatus 3 and the terminal apparatus 1 according to the present invention may be a program that controls a Central Processing Unit (CPU) and the like, such that the program causes a computer to operate in such a manner as to realize the functions of the above-described embodiment according to the present invention. The information handled in these apparatuses is temporarily stored in a Random Access Memory (RAM) while being processed. Thereafter, the information is stored in various types of Read Only Memory (ROM) such as a Flash ROM and a Hard Disk Drive (HDD), and when necessary, is read by the CPU to be modified or rewritten.

Note that the terminal apparatus 1 and the base station apparatus 3 according to the above-described embodiment may be partially achieved by a computer. In that case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as a peripheral apparatus. Furthermore, a “computer-readable recording medium” refers to a portable medium such as a flexible disk, a magneto-optical disk, a ROM, a CD-ROM, and the like, and a storage apparatus such as a hard disk built into the computer system.

Moreover, the “computer-readable recording medium” may include a medium that dynamically retains a program for a short period of time, such as a communication line in a case that the program is transmitted over a network such as the Internet or over a communication line such as a telephone line, and may also include a medium that retains the program for a fixed period of time, such as a volatile memory included in the computer system functioning as a server or a client in such a case. Furthermore, the above-described program may be one for realizing some of the above-described functions, and also may be one capable of realizing the above-described functions in combination with a program already recorded in a computer system.

Furthermore, the base station apparatus 3 according to the above-described embodiment may be achieved as an aggregation (apparatus group) including multiple apparatuses. Each of the apparatuses constituting such an apparatus group may include some or all portions of each function or each functional block of the base station apparatus 3 according to the above-described embodiment. The apparatus group is required to have a complete set of functions or functional blocks of the base station apparatus 3. Furthermore, the terminal apparatus 1 according to the above-described embodiment can also communicate with the base station apparatus as the aggregation.

Furthermore, the base station apparatus 3 according to the above-described embodiment may serve as an Evolved Universal Terrestrial Radio Access Network (EUTRAN). Furthermore, the base station apparatus 3 according to the above-described embodiment may have some or all of the functions of a node higher than an eNodeB.

Furthermore, some or all portions of each of the terminal apparatus 1 and the base station apparatus 3 according to the above-described embodiment may be typically achieved as an LSI which is an integrated circuit or may be achieved as a chip set. The functional blocks of each of the terminal apparatus 1 and the base station apparatus 3 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case where with advances in semiconductor technology, a circuit integration technology with which an LSI is replaced appears, it is also possible to use an integrated circuit based on the technology.

Furthermore, according to the above-described embodiment, the terminal apparatus has been described as an example of a communication apparatus, but the present invention is not limited to such a terminal apparatus, and is applicable to a terminal apparatus or a communication apparatus of a fixed-type or a stationary-type electronic apparatus installed indoors or outdoors, for example, such as an Audio-Visual (AV) apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

1. A terminal apparatus comprising:
a processor; and
a memory coupled to the processor and storing instructions, wherein the processor is configured to execute the instructions to
receive a physical downlink control channel (PDCCH) accompanied with a downlink control information (DCI) format, and
receive a physical downlink shared channel (PDSCH) corresponding to a resource indication value (RIV) set to a “Frequency domain resource assignment” field of the DCI format, wherein
the RIV is based on at least a type of a search space in which the PDCCH is detected, and
in a case that
the terminal apparatus is configured to monitor a first PDCCH candidate in a common search space (CSS) and a second PDCCH candidate in a UE-specific search space (USS) according to the DCI format accompanied with a cell radio network temporary identifier (C-RNTI) in one control resource set (CORESET),
a period of the CORESET is one orthogonal frequency division multiplexing (OFDM) symbol,
the CORESET is a non-interleaved CORESET,
one of the first PDCCH candidate and the second PDCCH candidate is of an aggregation level of 8 and the other of the first PDCCH candidate and the second PDCCH candidate is of an aggregation level of 16,
a lowest index of a control channel element (CCE) constituting the first PDCCH candidate is identical to a lowest index of a CCE constituting the second PDCCH candidate,
a higher layer parameter PDCCH-DMRS-Scrambling-ID is not configured for the CORESET, or
a size of the DCI format corresponding to the first PDCCH candidate is identical to a size of the DCI format corresponding to the second PDCCH candidate, the processor is further configured to execute the instructions to consider that
the PDCCH accompanied with the DCI format is transmitted only in the first PDCCH candidate out of the first PDCCH candidate and the second PDCCH candidate,
the PDCCH accompanied with the DCI format is transmitted only in the second PDCCH candidate out of the first PDCCH candidate and the second PDCCH candidate,
the PDCCH accompanied with the DCI format is transmitted or received in the second PDCCH candidate in a case that the PDCCH accompanied with the DCI format is received in the first PDCCH candidate,
the PDCCH accompanied with the DCI format is transmitted or received in the first PDCCH candidate in a case that the PDCCH accompanied with the DCI format is received in the second PDCCH candidate,
the PDCCH accompanied with the DCI format is transmitted only in the PDCCH candidate having the aggregation level of 8,
the PDCCH accompanied with the DCI format is transmitted only in the PDCCH candidate having the aggregation level of 16,
the PDCCH accompanied with the DCI format is transmitted or received in the PDCCH candidate having the aggregation level of 16 in a case that the PDCCH accompanied with the DCI format is detected in the PDCCH candidate having the aggregation level of 8, or
the PDCCH accompanied with the DCI format is transmitted or received in the PDCCH candidate having the aggregation level of 8 in a case that the PDCCH accompanied with the DCI format is detected in the PDCCH candidate having the aggregation level of 16.

2. The terminal apparatus according to claim 1, wherein a set of fields of the DCI format corresponding to the first PDCCH candidate is identical to a set of fields of the DCI format corresponding to the second PDCCH candidate.

3. The terminal apparatus according to claim 1, wherein the DCI format is at least one of a DCI format 0_0 and a DCI format 1_0.

4. The terminal apparatus according to claim 1, wherein
a scrambling sequence c_{PDCCH}(i) used for scrambling the PDCCH is initialized using c_{PDCCH_init},
c_{PDCCH_init} is based on at least n_{RNTI},
n_{RNTI} is the C-RNTI for the PDCCH in the USS in a case that the higher layer parameter PDCCH-DMRS-Scrambling-ID is configured for the CORESET,
n_{RNTI} is 0 in a case that the higher layer parameter PDCCH-DMRS-Scrambling-ID is not configured for the CORESET, and
C-RNTI is not 0.

5. A base station apparatus comprising:
a processor; and
a memory coupled to the processor and storing instructions, wherein the processor is configured to execute the instructions to
transmit a physical downlink control channel (PDCCH) accompanied with a downlink control information (DCI) format, and
transmit a physical downlink shared channel (PDSCH) corresponding to a resource indication value (RIV) set to a “Frequency domain resource assignment” field of the DCI format, wherein
the RIV is based on at least a type of a search space in which the PDCCH is detected, and
in a case that
the terminal apparatus is configured to monitor a first PDCCH candidate in a common search space (CSS) and a second PDCCH candidate in a UE-specific search space (USS) according to the DCI format accompanied with a cell radio network temporary identifier (C-RNTI) in one control resource set (CORESET),
a period of the CORESET is one orthogonal frequency division multiplexing (OFDM) symbol,
the CORESET is a non-interleaved CORESET,
one of the first PDCCH candidate and the second PDCCH candidate is of an aggregation level of 8 and the other of the first PDCCH candidate and the second PDCCH candidate is of an aggregation level of 16,
a lowest index of a control channel element (CCE) constituting the first PDCCH candidate is identical to a lowest index of a CCE constituting the second PDCCH candidate,
a higher layer parameter PDCCH-DMRS-Scrambling-ID is not configured for the CORESET, or
a size of the DCI format corresponding to the first PDCCH candidate is identical to a size of the DCI format corresponding to the second PDCCH candidate, the processor is further configured to execute the instructions to
transmit the PDCCH accompanied with the DCI format only in the first PDCCH candidate out of the first PDCCH candidate and the second PDCCH candidate,
transmit the PDCCH accompanied with the DCI format only in the second PDCCH candidate out of the first PDCCH candidate and the second PDCCH candidate,
consider that the PDCCH accompanied with the DCI format is transmitted in the second PDCCH candidate in a case that the PDCCH accompanied with the DCI format is transmitted in the first PDCCH candidate,
consider that the PDCCH accompanied with the DCI format is transmitted in the first PDCCH candidate in a case that the PDCCH accompanied with the DCI format is transmitted in the second PDCCH candidate,
transmit the PDCCH accompanied with the DCI format only in the PDCCH candidate having the aggregation level of 8 out of the first PDCCH candidate and the second PDCCH candidate,
transmit the PDCCH accompanied with the DCI format only in the PDCCH candidate having the aggregation level of 16 out of the first PDCCH candidate and the second PDCCH candidate,
consider that the PDCCH accompanied with the DCI format is transmitted in the PDCCH candidate having the aggregation level of 16 in a case that the PDCCH accompanied with the DCI format is transmitted in the PDCCH candidate having the aggregation level of 8, or
consider that the PDCCH accompanied with the DCI format is transmitted in the PDCCH candidate having the aggregation level of 8 in a case that the PDCCH accompanied with the DCI format is transmitted in the PDCCH candidate having the aggregation level of 16.

6. The base station apparatus according to claim 5, wherein a set of fields of the DCI format corresponding to the first PDCCH candidate is identical to a set of fields of the DCI format corresponding to the second PDCCH candidate.

7. The base station apparatus according to claim 5, wherein the DCI format is at least one of a DCI format 0_0 and a DCI format 1_0.

8. The base station apparatus according to claim 5, wherein
a scrambling sequence c_{PDCCH}(i) used for scrambling of the PDCCH is initialized using C_{PDCCH_init},
c_{PDCCH_init} is based on at least n_{RNTI},
n_{RNTI} is the C-RNTI for the PDCCH in the USS in a case that the higher layer parameter PDCCH-DMRS-Scrambling-ID is configured for the CORESET,
n_{RNTI} is 0 in a case that the higher layer parameter PDCCH-DMRS-Scrambling-ID is not configured for the CORESET, and
C-RNTI is not 0.

9. A communication method used for a terminal apparatus, the communication method comprising:
receiving a physical downlink control channel (PDCCH) accompanied with a downlink control information (DCI) format; and
receiving a physical downlink shared channel (PDSCH) corresponding to a resource indication value (RIV) set to a “Frequency domain resource assignment” field of the DCI format, wherein:
the RIV is based on at least a type of a search space in which the PDCCH is detected; and
in a case that
the terminal apparatus is configured to monitor a first PDCCH candidate in a common search space (CSS) and a second PDCCH candidate in a UE-specific search space (USS) according to the DCI format accompanied with a cell radio network temporary identifier (C-RNTI) in one control resource set (CORESET),
a period of the CORESET is one orthogonal frequency division multiplexing (OFDM) symbol,
the CORESET is a non-interleaved CORESET,
one of the first PDCCH candidate and the second PDCCH candidate is of an aggregation level of 8 and the other of the first PDDCH candidate and the second PDCCH candidate is of an aggregation level of 16,
that a lowest index of a control channel element (CCE) constituting the first PDCCH candidate is identical to a lowest index of a CCE constituting the second PDCCH candidate,
a higher layer parameter PDCCH-DMRS-Scrambling-ID is not configured for the CORESET, or
a size of the DCI format corresponding to the first PDCCH candidate is identical to a size of the DCI format corresponding to the second PDCCH candidate, considering that
the PDCCH accompanied with the DCI format is transmitted only in the first PDCCH candidate out of the first PDCCH candidate and the second PDCCH candidate,
the PDCCH accompanied with the DCI format is transmitted only in the second PDCCH candidate out of the first PDCCH candidate and the second PDCCH candidate,
the PDCCH accompanied with the DCI format is transmitted or received in the second PDCCH candidate in a case that the PDCCH accompanied with the DCI format is received in the first PDCCH candidate,
the PDCCH accompanied with the DCI format is transmitted or received in the first PDCCH candidate in a case that the PDCCH accompanied with the DCI format is received in the second PDCCH candidate,
the PDCCH accompanied with the DCI format is transmitted only in the PDCCH candidate having the aggregation level of 8,
the PDCCH accompanied with the DCI format is transmitted only in the PDCCH candidate having the aggregation level of 16,
the PDCCH accompanied with the DCI format is transmitted or received in the PDCCH candidate having the aggregation level of 16 in a case that the PDCCH accompanied with the DCI format is detected in the PDCCH candidate having the aggregation level of 8, or
the PDCCH accompanied with the DCI format is transmitted or received in the PDCCH candidate having the aggregation level of 8 in a case that the PDCCH accompanied with the DCI format is detected in the PDCCH candidate having the aggregation level of 16.

10. (canceled)

11. The method according to claim 9, wherein a set of fields of the DCI format corresponding to the first PDCCH candidate is identical to a set of fields of the DCI format corresponding to the second PDCCH candidate.

12. The method according to claim 9, wherein the DCI format is at least one of a DCI format 0_0 and a DCI format 1_0.

13. The method according to claim 9, wherein
a scrambling sequence c_{PDCCH(i)} used for scrambling the PDCCH is initialized using C_{PDCCH_init},
c_{PDCCH_init} is based on at least n_{RNTI},
n_{RNTI} is the C-RNTI for the PDCCH in the USS in a case that the higher layer parameter PDCCH-DMRS-Scrambling-ID is configured for the CORESET,
n_{RNTI} is 0 in a case that the higher layer parameter PDCCH-DMRS-Scrambling-ID is not configured for the CORESET, and
C-RNTI is not 0.
